(19) United States
(12) Patent Application Publication
(10) Pub. No.: US 2007/0270521 A1
(43) Pub. Date: Nov. 22, 2007

(54) Transition metal compound, polymerization-initiator system comprising the same, and process for producing polymer

(75) Inventors: Makoto Uemura, Chiba-shi (JP); Masayuki Fujita, Chiba-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/705,011

(22) Filed: Feb. 12, 2007

(30) Foreign Application Priority Data
Feb. 14, 2006 (JP) 2006-036164

(51) Int. Cl. C07F 15/00

(52) U.S. Cl. 522/66; 556/41

(57) ABSTRACT

A transition metal compound represented by the formula, [(CpR¹ₘ)(CO)₂M¹][M²(CO)₂(CpR²ₙ)], wherein Cp is a cyclopentadienyl ring, R¹ and R² are independently of each other a hydrocarbyl group having 1 to 20 carbon atoms, and each of at least one R¹ and at least one R² is a hydrocarbyl group having 5 to 20 carbon atoms, m and n are independently of each other an integer of 1 to 5, and M¹ and M² are independently of each other a transition metal atom of the group 8 in the periodic table of elements; a polymerization-initiator system comprising said transition metal compound; and a process for producing a polymer in the presence of the polymerization-initiator system.

### FIELD OF THE INVENTION

The present invention relates to a transition metal compound, a polymerization-initiator system comprising the transition metal compound, and a process for producing a polymer in the presence of the polymerization-initiator system.

### BACKGROUND OF THE INVENTION

JP 2004-51934A discloses a process for producing a non-polar olefin-polar olefin copolymer, which comprises the step of copolymerizing a non-polar olefin such as an α-olefin with a polar olefin such as an acrylic ester in the presence of a polymerization-initiator system comprising (i) a metal complex having a central metal atom of a ruthenium or iron atom, and (ii) a halogen-containing organic compound.

### SUMMARY OF THE INVENTION

When using a solution of the above-mentioned metal complex having a central metal atom of a ruthenium or iron atom in an aliphatic hydrocarbon solvent as a component of a polymerization-initiator system (for example, a controlled radical polymerization-initiator system), however, there is a problem in that solubility thereof in said solvent and stability thereof during polymerization are not necessarily sufficient, and therefore, a satisfactory polymerization activity may not be obtained.

In view of the above-mentioned problem in the conventional art, the present invention has an object to provide (i) a transition metal compound, which has excellent solubility in a solvent, excellent stability during polymerization, and excellent polymerization activity, (ii) a polymerization-initiator system comprising the transition metal compound, and (iii) a process for producing a polymer in the presence of the polymerization-initiator system.

The present invention is a transition metal compound represented by the following formula (1):
[(CpR¹ₘ)(CO)₂M¹][M²(CO)₂(CpR²ₙ)] (1)
wherein Cp is a cyclopentadienyl ring; R¹ and R² are independently of each other a hydrocarbyl group having 1 to 20 carbon atoms, and each of at least one R¹ and at least one R² is a hydrocarbyl group having 5 to 20 carbon atoms; m and n are independently of each other an integer of 1 to 5; and M¹ and M² are independently of each other a transition metal atom of the group 8 in the periodic table of elements.

Also, the present invention is a polymerization-initiator system, which comprises the above-mentioned transition metal compound, or comprises said transition metal compound and a halogen-containing organic compound.

Further, the present invention is a process for producing a polymer, which comprises the step of (i) polymerizing at least one kind of a polar monomer selected from the group consisting of an unsaturated carboxylic acid, an unsaturated carboxylic ester, an unsaturated carboxylic amide, a vinyl ether, a vinyl ester, an unsaturated nitrile, an unsaturated aldehyde and an unsaturated ketone, or (ii) polymerizing at least one kind of an olefin, or (iii) polymerizing the above-mentioned polar monomer and an olefin, in the presence of the above-mentioned polymerization-initiator system.

### DETAILED DESCRIPTION OF THE INVENTION

The transition metal compound represented by the above-mentioned formula (1) is represented by the following formula (1a), (1b) or (1c) according to a coordination state of four carbonyl groups with M¹ and M², and the presence or absence of a linkage between M¹ and M²:

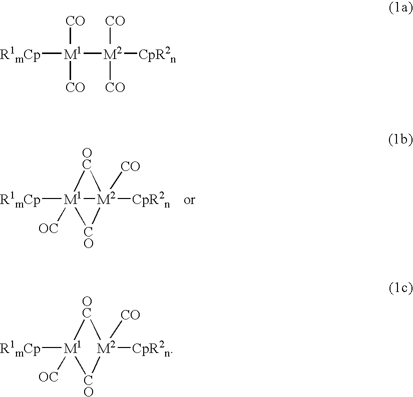

In the above-mentioned formula (1a), two of four carbonyl groups coordinate to M¹, and remaining two thereof coordinate to M², M¹ and M² linking to each other. In the above-mentioned formula (1b), two of four carbonyl groups coordinate to M¹ and M², respectively, and remaining two thereof coordinate to both M¹ and M², respectively, M¹ and M² linking to each other. In the above-mentioned formula (1c), two of four carbonyl groups coordinate to M¹ and M², respectively, and remaining two thereof coordinate to both M¹ and M², respectively, M¹ and M² not linking to each other.

Examples of the transition metal atom of the group 8 in the periodic table of elements (IUPAC 1985) of M¹ and M² are an iron atom, a ruthenium atom and an osmium atom. A combination of M¹ with M² are not particularly limited, and examples thereof are a combination of iron atoms, that of an iron atom with a ruthenium atom, that of an iron atom with an osmium atom, that of ruthenium atoms, that of a ruthenium atom with an osmium atom, and that of osmium atoms. Among them, preferred is a combination of iron atoms from an economical point of view.

In the formula (1), R¹ₘCp is a cyclopentadienyl ring having the substituent of R¹ in the number of m, and coordinating to M¹. When m is 5, R¹₅Cp is represented by the following formula (2): 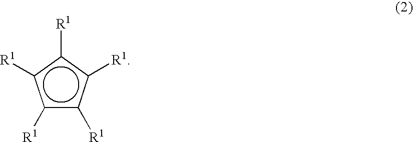
In the formula (1), CpR²ₙ is a cyclopentadienyl ring having the substituent of R² in the number of n, and coordinating to M². When n is 5, CpR²₅ is represented by the above-mentioned formula (2), wherein five R¹s are replaced with five R²s.

Examples of the hydrocarbyl group having 1 to 20 carbon atoms of R¹ and R² are a linear saturated hydrocarbyl group, a branched saturated hydrocarbyl group, a cyclic saturated hydrocarbyl group, a linear unsaturated hydrocarbyl group, a branched unsaturated hydrocarbyl group, and a cyclic unsaturated hydrocarbyl group.

Examples of the linear saturated hydrocarbyl group are a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-eicosyl group.

Examples of the branched saturated hydrocarbyl group are an isopropyl group, a sec-butyl group, a tert-butyl group, a 2-methylbutyl group, a 2-methylpentyl group, a neopentyl group, a 2-methylhexyl group, a 2-methylheptyl group, a 2-methyloctyl group, a 2-methylnonyl group, a 2-methyldecyl group, a 2-methylundecyl group, a 2-methyldodecyl group, a 2-methyltridecyl group, a 2-methyltetradecyl group, a 2-methylpentadecyl group, a 2-methylhexadecyl group, a 2-methylheptadecyl group, a 2-methyloctadecyl group, a 2-methylnonadecyl group, 3-methylbutyl group, a 3-methylpentyl group, a 3-methylhexyl group, a 3-methylheptyl group, a 3-methyloctyl group, a 3-methylnonyl group, a 3-methyldecyl group, a 3-methylundecyl group, a 3-methyldodecyl group, a 3-methyltridecyl group, a 3-methyltetradecyl group, a 3-methylpentadecyl group, a 3-methylhexadecyl group, a 3-methylheptadecyl group, a 3-methyloctadecyl group, a 3-methylnonadecyl group, a 2,2-dimethylbutyl group, a 2,2-dimethylpentyl group, a 2,2-dimethylhexyl group, a 2,2-dimethylheptyl group, a 2,2-dimethyloctyl group, a 2,2-dimethylnonyl group, a 2,2-dimethyldecyl group, a 2,2-dimethylundecyl group, a 2,2-dimethyldodecyl group, a 2,2-dimethyltridecyl group, a 2,2-dimethyltetradecyl group, a 2,2-dimethylpentadecyl group, a 2,2-dimethylhexadecyl group, a 2,2-dimethylheptadecyl group, a 2,2-dimethyloctadecyl group, a 2,3-dimethylbutyl group, a 2,3-dimethylpentyl group, a 2,3-dimethylhexyl group, a 2,3-dimethylheptyl group, a 2,3-dimethyloctyl group, a 2,3-dimethylnonyl group, a 2,3-dimethyldecyl group, a 2,3-dimethylundecyl group, a 2,3-dimethyldodecyl group, a 2,3-dimethyltridecyl group, a 2,3-dimethyltetradecyl group, a 2,3-dimethylpentadecyl group, a 2,3-dimethylhexadecyl group, a 2,3-dimethylheptadecyl group, and a 2,3-dimethyloctadecyl group; and structural isomers of those groups.

Examples of the cyclic saturated hydrocarbyl group are a cyclopropyl group, a cyclobutyl group, a cyclopentyl group, a cyclohexyl group, a cycloheptyl group, a cyclooctyl group, a cyclononyl group, a cyclodecyl group, a cycloundecyl group, a cyclododecyl group, a cyclotridecyl group, a cyclotetradecyl group, a cyclopentadecyl group, a cyclohexadecyl group, a cycloheptadecyl group, a cyclooctadecyl group, a cyclononadecyl group, and a cycloeicosyl group; and structural isomers of those groups.

Examples of the linear unsaturated hydrocarbyl group are an ethylenyl group, a n-propenyl group, a n-butenyl group, a n-pentenyl group, a n-hexenyl group, a n-heptenyl group, a n-octenyl group, a n-nonenyl group, a n-decenyl group, a n-undecenyl group, a n-dodecenyl group, a n-tridecenyl group, a n-tetradecenyl group, a n-pentadecenyl group, a n-hexadecenyl group, a n-heptadecenyl group, a n-octadecenyl group, a n-nonadecenyl group, and a n-eicosenyl group.

Examples of the branched unsaturated hydrocarbyl group are a 2-propenyl group, a 2-methyl-1-propenyl group, a 2-methyl-2-butenyl group, a 2-methyl-2-pentenyl group, a 2-methyl-2-hexenyl, group, a 2-methyl-2-heptenyl group, a 2-methyl-2-octenyl group, a 2-methyl-2-nonenyl group, a 2-methyl-2-decenyl group, a 2-methyl-2-undecenyl group, a 2-methyl-2-dodecenyl group, a 2-methyl-2-tridecenyl group, a 2-methyl-2-tetradecenyl group, a 2-methyl-2-pentadecenyl group, a 2-methyl-2-hexadecenyl group, a 2-methyl-2-heptadecenyl group, a 2-methyl-2-octadecenyl group, a 2-methyl-2-nonadecenyl group, a 2,2-dimethyl-2-butenyl group, a 2,2-dimethyl-2-pentenyl group, a 2,2-dimethyl-2-hexenyl group, a 2,2-dimethyl-2-heptenyl group, a 2,2-dimethyl-2-octenyl group, a 2,2-dimethyl-2-nonenyl group, a 2,2-dimethyl-2-decenyl group, a 2,2-dimethyl-2-undecenyl group, a 2,2-dimethyl-2-dodecenyl group, a 2,2-dimethyl-2-tridecenyl group, a 2,2-dimethyl-2-tetradecenyl group, a 2,2-dimethyl-2-pentadecenyl group, a 2,2-dimethyl-2-hexadecenyl group, a 2,2-dimethyl-2-heptadecenyl group, a 2,2-dimethyl-2-octadecenyl group, a 2,3-dimethyl-2-butenyl group, a 2,3-dimethyl-2-pentenyl group, a 2,3-dimethyl-2-hexenyl group, a 2,3-dimethyl-2-heptenyl group, a 2,3-dimethyl-2-octenyl group, a 2,3-dimethyl-2-nonenyl group, a 2,3-dimethyl-2-decenyl group, a 2,3-dimethyl-2-undecenyl group, a 2,3-dimethyl-2-dodecenyl group, a 2,3-dimethyl-2-tridecenyl group, a 2,3-dimethyl-2-tetradecenyl group, a 2,3-dimethyl-2-pentadecenyl group, a 2,3-dimethyl-2-hexadecenyl group, a 2,3-dimethyl-2-heptadecenyl group, and a 2,3-dimethyl-2-octadecenyl group; and structural isomers of those groups.

Examples of the cyclic unsaturated hydrocarbyl group are a cyclopropenyl group, a cyclobutenyl group, a cyclopentenyl group, a cyclohexenyl group, a cycloheptenyl group, a cyclooctenyl group, a cyclononenyl group, a cyclodecenyl group, a cycloundecenyl group, a cyclododecenyl group, a cyclotridecenyl group, a cyclotetradecenyl group, a cyclopentadecenyl group, a cyclohexadecenyl group, a cycloheptadecenyl group, a cyclooctadecenyl group, a cyclononadecenyl group, a cycloeicosenyl group, a phenyl group, a toluoyl group, a xylyl group, a biphenyl group, a 1-naphthyl group, a 2-naphthyl group, a 1-anthracenyl group, a 2-anthracenyl group, a 1-indenyl group, a 2-indenyl group, and a benzyl group; and structural isomers of those groups.

Each of at least one R¹ and at least one R² in the formula (1) is a hydrocarbyl group having 5 to 20 carbon atoms, preferably a saturated hydrocarbyl group having 8 to 20 carbon atoms, and more preferably a linear saturated hydrocarbyl group having 8 to 20 carbon atoms, from a viewpoint of solubility of the transition metal compound of the present invention in a hydrocarbon solvent.

The transition metal compound of the present invention is preferably a transition metal compound represented by the formula, [(CpR¹₅)(CO)₂M¹][M²(CO)₂(CpR²₅)], wherein each of one R¹ and one R² is a hydrocarbyl group having 5 to 20 carbon atoms, and all the remaining four R¹s and four R²s are a methyl group, from a viewpoint of stability thereof during polymerization and availability of starting materials for them.

Examples of the transition metal compound are preferably a compound having a combination of M¹ with M² of iron atoms such as [n-pentyl(tetramethyl)cyclopentadienyl]iron carbonyl dimer, [n-hexyl(tetramethyl)cyclopentadienyl]iron carbonyl dimer, [n-heptyl(tetramethyl)cyclopentadienyl]iron carbonyl dimer, [n-octyl(tetramethyl)cyclopentadienyl]iron carbonyl dimer, [n-nonyl(tetramethyl)cyclopentadienyl]iron carbonyl dimer, [n-decyl(tetramethyl)cyclopentadienyl]iron carbonyl dimer, [n-undecyl(tetramethyl)cyclopentadienyl]iron carbonyl dimer, [n-dodecyl(tetramethyl)cyclopentadienyl]iron carbonyl dimer, [n-tridecyl(tetramethyl)cyclopentadienyl]iron carbonyl dimer, [n-tetradecyl(tetramethyl)cyclopentadienyl]iron carbonyl dimer, [n-pentadecyl(tetramethyl)cyclopentadienyl]iron carbonyl dimer, [n-hexadecyl(tetramethyl)cyclopentadienyl]iron carbonyl dimer, [n-heptadecyl(tetramethyl)cyclopentadienyl]iron carbonyl dimer, [n-octadecyl(tetramethyl)cyclopentadienyl]iron carbonyl dimer, [n-nonadecyl(tetramethyl)cyclopentadienyl]iron carbonyl dimer, [n-eicosyl(tetramethyl)cyclopentadienyl]iron carbonyl dimer, [sec-pentyl(tetramethyl)cyclopentadienyl]iron carbonyl dimer, [neopentyl(tetramethyl)cyclopentadienyl]iron carbonyl dimer, [sec-hexyl(tetramethyl)cyclopentadienyl]iron carbonyl dimer, [sec-heptyl(tetramethyl)cyclopentadienyl]iron carbonyl dimer, [sec-octyl(tetramethyl)cyclopentadienyl]iron carbonyl dimer, [sec-nonyl(tetramethyl)cyclopentadienyl]iron carbonyl dimer, [sec-decyl(tetramethyl)cyclopentadienyl]iron carbonyl dimer, [sec-undecyl(tetramethyl)cyclopentadienyl]iron carbonyl dimer, [sec-dodecyl(tetramethyl)cyclopentadienyl]iron carbonyl dimer, [sec-tridecyl(tetramethyl)cyclopentadienyl]iron carbonyl dimer, [sec-tetradecyl(tetramethyl)cyclopentadienyl]iron carbonyl dimer, [sec-pentadecyl(tetramethyl)cyclopentadienyl]iron carbonyl dimer, [sec-hexadecyl(tetramethyl)cyclopentadienyl]iron carbonyl dimer, [sec-heptadecyl(tetramethyl)cyclopentadienyl]iron carbonyl dimer, [sec-octadecyl(tetramethyl)cyclopentadienyl]iron carbonyl dimer, [sec-nonadecyl(tetramethyl)cyclopentadienyl]iron carbonyl dimer, [sec-eicosyl(tetramethyl)cyclopentadienyl]iron carbonyl dimer, [cyclopentyl(tetramethyl)cyclopentadienyl]iron carbonyl dimer, [cyclohexyl(tetramethyl)cyclopentadienyl]iron carbonyl dimer, [cycloheptyl(tetramethyl)cyclopentadienyl]iron carbonyl dimer, [cyclooctyl(tetramethyl)cyclopentadienyl]iron carbonyl dimer, [cyclononyl(tetramethyl)cyclopentadienyl]iron carbonyl dimer, [cyclodecyl(tetramethyl)cyclopentadienyl]iron carbonyl dimer, [cycloundecyl(tetramethyl)cyclopentadienyl]iron carbonyl dimer, [cyclododecyl(tetramethyl)cyclopentadienyl]iron carbonyl dimer, [cyclotridecyl(tetramethyl)cyclopentadienyl]iron carbonyl dimer, [cyclotetradecyl(tetramethyl)cyclopentadienyl]iron carbonyl dimer, [cyclopentadecyl(tetramethyl)cyclopentadienyl]iron carbonyl dimer, [cyclohexadecyl(tetramethyl)cyclopentadienyl]iron carbonyl dimer, [cycloheptadecyl(tetramethyl)cyclopentadienyl]iron carbonyl dimer, [cyclooctadecyl(tetramethyl)cyclopentadienyl]iron carbonyl dimer, [cyclononadecyl(tetramethyl)cyclopentadienyl]iron carbonyl dimer, and [cycloeicosyl(tetramethyl)cyclopentadienyl]iron carbonyl dimer; compounds obtained by changing the combination of M¹ with M² in the above-exemplified compounds to a combination of an iron atom with a ruthenium atom; compounds obtained by changing the combination of M¹ with M² therein to a combination of an iron atom with an osmium atom; compounds obtained by changing the combination of M¹ with M² therein to a combination of ruthenium atoms; compounds obtained by changing the combination of M¹ with M² therein to a combination of a ruthenium atom with an osmium atom; and compounds obtained by changing the combination of M¹ with M² therein to a combination of osmium atoms. Among them, more preferred is a compound having a combination of M¹ with M² of iron atoms from an economical point of view. The above-exemplified compounds may be used in combination of two or more thereof in the polymerization-initiator system of the present invention.

The transition metal compound represented by the formula (1), for example, a transition metal compound having a combination of M¹ with M² of iron atoms, can be produced according to a process comprising the steps of:
(1) reacting a halogenated hydrocarbon having 5 to 20 carbon atoms with a magnesium metal in a solvent such as tetrahydrofuran, thereby producing a Grignard reagent having a sterically-bulky long-chain hydrocarbyl group having 5 to 20 carbon atoms (said Grignard reagent may be a commercially available one);
(2) subjecting the Grignard reagent and a sterically-bulky cyclopentenone derivative to an alkylation reaction according to a method similarly to that disclosed in a document such as Journal of Organometallic Chemistry, Volume 579, pages 376-384 (1999) published by Elsevier Science S.A. (Netherlands), authored by Valeri Quindt, Dirk Saurenz, Oliver Schmitt, Marion Schaer, Thomas Dezember, Gotthelf Wolmershaeuser and Helmut Sitzmann, thereby producing a cyclopentadiene derivative having a hydrocarbyl group having 5 to 20 carbon atoms as a substituent; and
(3) reacting the cyclopentadiene derivative with iron pentacarbonyl according to a method similarly to that disclosed in a document such as Encyclopedia of Experimental Chemistry, Volume 18, pages 239-240, 4 th edition” (1991, MaruzenCo., Ltd.), edited by Chemical Society of Japan, thereby producing (cyclopentadienyl)iron carbonyl dimer, which has a hydrocarbyl group having 5 to 20 carbon atoms.

The transition metal compound represented by the formula (1) has excellent solubility in an organic solvent such as an aliphatic hydrocarbon and an aromatic hydrocarbon. A solution of said transition metal compound in an organic solvent can be used as a component of a polymerization-initiator system, which has excellent stability and excellent polymerization activity under polymerization conditions.

The polymerization-initiator system of the present invention comprises the transition metal compound represented by the formula (1), and preferably comprises said transition metal compound and a halogen-containing organic compound.

Examples of the halogen-containing organic compound are an α-halogenocarbonyl compound, an α-halogenocarboxylic ester, a halogenated hydrocarbon, and a (1-halogenoalkyl)benzene derivative.

Examples of the α-halogenocarbonyl compound are chloromethyl methyl ketone, 1,1,1-trichloromethyl methyl ketone, 1-chloroacetophenone, 1,1-dichloroacetophenone, bromomethyl methyl ketone, 1,1,1-tribromomethyl methyl ketone, 1-bromoacetophenone, 1,1-dibromoacetophenone, iodomethyl methyl ketone, 1-iodoacetophenone, 1,1-diiodoacetophenone, bromomethyl ethyl ketone, bromomethyl propyl ketone, 2-bromoethyl methyl ketone, 2-bromopropyl methyl ketone, 2-bromoethyl ethyl ketone, 2-bromopropyl propyl ketone, 2-bromopropyl methyl ketone, iodomethyl ethyl ketone, iodomethyl propyl ketone, 2-iodoethyl methyl ketone, 2-iodopropyl methyl ketone, 2-iodoethyl ethyl ketone, 2-iodopropyl propyl ketone, 2-iodopropyl methyl ketone, chloromethyl ethyl ketone, chloromethyl propyl ketone, 2-chloroethyl methyl ketone, 2-chloropropyl methyl ketone, 2-chloroethyl ethyl ketone, 2-chloropropyl propyl ketone, and 2-chloropropyl methyl ketone; and a combination of two or more thereof.

Examples of the α-halogenocarboxylic ester are methyl 2-chloroacetate, methyl 2-bromoacetate, methyl 2-iodoacetate, ethyl 2-chloroacetate, ethyl 2-bromoacetate, ethyl 2-iodoacetate, propyl 2-chloroacetate, propyl 2-bromoacetate, propyl 2-iodoacetate, butyl 2-chloroacetate, butyl 2-bromoacetate, butyl 2-iodoacetate, methyl 2,2,2-trichloroacetate, methyl 2,2-dichloroacetate, methyl 2,2,2-tribromoacetate, methyl 2,2-dibromoacetate, methyl 2,2,2-triiodoacetate, methyl 2,2-diiodoacetate, ethyl 2,2,2-trichloroacetate, ethyl 2,2-dichloroacetate, ethyl 2,2,2-tribromoacetate, ethyl 2,2-dibromoacetate, ethyl 2,2,2-triiodoacetate, ethyl 2,2-diiodoacetate, methyl 2-chloropropionate, methyl 2-bromopropionate, methyl 2-iodopropionate, methyl 2-chlorobutyrate, methyl 2-bromobutyrate, methyl 2-iodoprobutyrate, ethyl 2-chloropropionate, ethyl 2-bromopropionate, ethyl 2-iodopropionate, ethyl 2-chlorobutyrate, ethyl 2-bromobutyrate, ethyl 2-iodoprobutyrate, propyl 2-chloropropionate, propyl 2-bromopropionate, propyl 2-iodopropionate, propyl 2-chlorobutyrate, propyl 2-bromobutyrate, propyl 2-iodoprobutyrate, butyl 2-chloropropionate, butyl 2-bromopropionate, butyl 2-iodopropionate, butyl 2-chlorobutyrate, butyl 2-bromobutyrate, butyl 2-iodoprobutyrate, methyl 2-chloro-2-methylpropionate, methyl 2-bromo-2-methylpropionate, methyl 2-iodo-2-methylpropionate, ethyl 2-chloro-2-methylpropionate, ethyl 2-bromo-2-methylpropionate, ethyl 2-iodo-2-methylpropionate, methyl 2-chloro-2-methylbutyrate, methyl 2-bromo-2-methylbutyrate, methyl 2-iodo-2-methylbutyrate, ethyl 2-chloro-2-methylbutyrate, ethyl 2-bromo-2-methylbutyrate, ethyl 2-iodo-2-methylbutyrate, propyl 2-chloro-2-methylpropionate, propyl 2-bromo-2-methylpropionate, propyl 2-iodo-2-methylpropionate, propyl 2-chloro-2-methylpropionate, propyl 2-bromo-2-methylpropionate, propyl 2-iodo-2-methylpropionate, propyl 2-chloro-2-methylbutyrate, propyl 2-bromo-2-methylbutyrate, propyl 2-iodo-2-methylbutyrate, butyl 2-chloro-2-methylpropionate, butyl 2-bromo-2-methylpropionate, butyl 2-iodo-2-methylpropionate, butyl 2-chloro-2-methylbutyrate, butyl 2-bromo-2-methylbutyrate, butyl 2-iodo-2-methylbutyrate, dimethyl 2-chloro-2,4,4-trimethylglutarate, dimethyl 2-bromo-2,4,4-trimethylglutarate, dimethyl 2-iodo-2,4,4-trimethylglutarate, 1,2-bis(2′-bromo-2′-methylpropionyloxy)ethane, 1,2-bis(2′-iodo-2′-methylpropionyloxy)ethane, 1,2-bis(2′-bromopropionyloxy)ethane, 1,2-bis(2′-iodopropionyloxy)ethane, 2-(2′-bromo-2′-methylpropionyloxy)ethyl alcohol, and 2-(2′-iodo-2′-methylpropionyloxy)ethyl alcohol; and a combination of two or more thereof.

Examples of the halogenated hydrocarbon are carbon tetrachloride, chloroform, dichloromethane, chloromethane, carbon tetrabromide, bromoform, dibromomethane, bromomethane, carbon tetraiodide, iodoform, diiodomethane, iodomethane, iodoethane, 1-iodopropane, 2-iodopropane, 1-iodobutane, 2-iodobutane, 1-iodoisobutane, 2-iodoisobutane, 1-iodopentane, 2-iodopentane, 3-iodopentane, 1-iodoisopentane, 2-iodoisopentane, 3-iodoisopentane, 1-iodohexane, 2-iodohexane, 3-iodohexane, 1-iodoisohexane, 2-iodoisohexane, 3-iodoisohexane, 1-iodocyclopropane, 1-iodocyclobutane, 1-iodocyclopentane, 1-iodocyclohexane, 1,1-diiodoethane, 1,2-diiodoethane, 1,3-diiodopropane, 1,4-diiodobutane, 1,5-diiodopentane, 1,6-diiodohexane, 1,8-diiodooctane, 1,10-diiododecane, 1,12-diiodododecane, bromoethane, 1-bromopropane, 2-bromopropane, 1-bromobutane, 2-bromobutane, 1-bromoisobutane, 2-bromoisobutane, 1-bromopentane, 2-bromopentane, 3-bromopentane, 1-bromoisopentane, 2-bromoisopentane, 3-bromoisopentane, 1-bromohexane, 2-bromohexane, 3-bromohexane, 1-bromoisohexane, 2-bromoisohexane, 3-bromoisohexane, 1-bromocyclopropane, 1-bromocyclobutane, 1-bromocyclopentane, 1-bromocyclohexane, 1,1-dibromoethane, 1,2-dibromoethane, 1,3-dibromopropane, 1,4-dibromobutane, 1,5-dibromopentane, 1,6-dibromohexane, 1,8-dibromooctane, 1,10-dibromodecane, 1,12-dibromododecane, chloroethane, 1-chloropropane, 2-chloropropane, 1-chlorobutane, 2-chlorobutane, 1-chloroisobutane, 2-chloroisobutane, 1-chloropentane, 2-chloropentane, 3-chloropentane, 1-chloroisopentane, 2-chloroisopentane, 3-chloroisopentane, 1-chlorohexane, 2-chlorohexane, 3-chlorohexane, 1-chloroisohexane, 2-chloroisohexane, 3-chloroisohexane, 1-chlorocyclopropane, 1-chlorocyclobutane, 1-chlorocyclopentane, 1-chlorocyclohexane, 1,1-dichloroethane, 1,2-dichloroethane, 1,3-dichloropropane, 1,4-dichlorobutane, 1,5-dichloropentane, 1,6-dichlorohexane, 1,8-dichlorooctane, 1,10-dichlorodecane, 1,12-dichlorododecane, 1-chloro-1-iodoethane, 1-chloro-2-iodoethane, 1-chloro-3-iodopropane, 1-chloro-4-iodobutane, 1-chloro-5-iodopentane, 1-chloro-6-iodohexane, 1-chloro-8-iodooctane, 1-chloro-10-iododecane, 1-chloro-12-iodododecane, 1-bromo-1-iodoethane, 1-bromo-2-iodoethane, 1-bromo-3-iodopropane, 1-bromo-4-iodobutane, 1-bromo-5-iodopentane, 1-bromo-6-iodohexane, 1-bromo-8-iodooctane, 1-bromo-10-iododecane, 1-bromo-12-iodododecane, 1-bromo-1-chloroethane, 1-bromo-2-chloroethane, 1-bromo-3-chloropropane, 1-bromo-4-chlorobutane, 1-bromo-5-chloropentane, 1-bromo-6-chlorohexane, 1-bromo-8-chlorooctane, 1-bromo-10-chlorodecane, and 1-bromo-12-chlorododecane; and a combination of two or more thereof.

Examples of the (1-halogenoalkyl)benzene derivative are 1-bromo-1-phenylethane, 4-(1-bromoethyl)benzoic acid, a 4-(1-bromoethyl)benzoic ester, 1-chloro-1-phenylethane, 4-(1-chloroethyl)benzoic acid, a 4-(1-chloroethyl)benzoic ester, 1-bromo-1-phenylethane, 4-(1-bromoethyl)benzoic acid, a 4-(1-bromoethyl)benzoic ester, 1-iodo-1-phenylethane, 4-(1-iodoethyl)benzoic acid, and a 4-(1-iodoethyl)benzoic ester; and a combination of two or more thereof.

Among them, the halogen-containing organic compound is preferably an α-halogenocarbonyl compound, an α-halogenocarboxylic ester, or a halogenated hydrocarbon, and more preferably ethyl 2-bromo-2-methylpropionate, ethyl 2-iodopropionate or 2-iodobutane.

The transition metal compound represented by the formula (1) and the halogen-containing organic compound, which are contained in the polymerization-initiator system of the present invention, may be combined with other component such as a compound containing the group 3, 13, 15 or 16 atom in the periodic table of elements.

An example of the compound containing the group 3 atom is a rare earth compound. Examples of the rare earth compound are a scandium compound such as scandium(III) acetylacetonate, scandium(III) trifluoromethanesulfonate, scandium(III) trifluoroacetate, scandium(III) acetate and scandium(III) chloride; a yttrium compound such as yttrium(III) acetylacetonate, yttrium(III) trifluoromethanesulfonate, yttrium(III) trifluoroacetate, yttrium(III) acetate and yttrium(III) chloride; a lanthamide compound such as lanthamide(III) acetylacetonate, lanthamide(III) trifluoromethanesulfonate, lanthamide(III) trifluoroacetate, lanthamide(III) acetate and lanthamide(III) chloride; a cerium compound such as cerium(III) acetylacetonate, cerium(III) trifluoromethanesulfonate, cerium(III) trifluoroacetate, cerium(III) acetate and cerium(III) chloride; a neodymium compound such as neodymium(III) acetylacetonate, neodymium(III) trifluoromethanesulfonate, neodymium(III) trifluoroacetate, neodymium(III) acetate and neodymium(III) chloride; a samarium compound such as samarium(III) acetylacetonate, samarium(III) trifluoromethanesulfonate, samarium(III) trifluoroacetate, samarium(III) acetate and samarium(III) chloride; a europium compound such as europium(III) acetylacetonate, europium(III) trifluoromethanesulfonate, europium(III) trifluoroacetate, europium(III) acetate and europium(III) chloride; a gadolinium compound such as gadolinium(III) acetylacetonate, gadolinium(III) trifluoromethanesulfonate, gadolinium(III) trifluoroacetate, gadolinium(III) acetate and gadolinium(III) chloride; a terbium compound such as terbium(III) acetylacetonate, terbium(III) trifluoromethanesulfonate, terbium(III) trifluorbacetate, terbium(III) acetate and terbium(III) chloride; and a ytterbium compound such as ytterbium(III) acetylacetonate, ytterbium(III) trifluoromethanesulfonate, ytterbium(III) trifluoroacetate, ytterbium(III) acetate and ytterbium(III) chloride.

Examples of the compound containing the group 13 atom are a boron compound and an aluminum compound. Examples of the boron compound are a boron halide such as boron trichloride and boron tribromide; an arylborane such as triphenylborane and tris(pentafluorophenyl)borane; an alkylborane such as triethylborane and tricyclohexylborane; and an onium salt boron compound such as anilinium borate. Examples of the aluminum compound are a trialkylaluminum such as trimethylaluminum, triethylaluminum and triisobutylaluminum; an aluminum halide such as trichloroaluminum; an aluminum alkoxide such as triisopropoxyaluminum; diethylaluminum chloride; ethylaluminum dichloride; diethylisopropoxyaluminum; and ethylisopropoxyaluminum chloride.

Examples of the compound containing the group 15 atom are a nitrogen compound and a phosphor compound. Examples of the nitrogen compound are an amine compound such as triethylamine, diisopropylamine, ethyldiisopropylamine and butylamine; an imine compound such as 1,2-ethanediimine and 2,4-pentanediimine; a heterocyclic compound such as pyridine, lutidine, collidine, pyrrole and pyrrolidine; and a nitroxide compound such as 2,2,6,6-tetramethylpyridine-1-oxyl and 4-hydroxy-2,2,6,6-tetramethylpyridine-1-oxyl. Examples of the phosphor compound are a trialkylphosphor compound such as triethylphosphine, tributylphosphine and tricyclohexylphosphine; and a triarylphosphor compound such triphenylphosphine.

Examples of the compound containing the group 16 atom are an oxygen compound and a sulfur compound. Examples of the oxygen compound are a ketone compound such as acetylacetone; an ester compound such as diethyl maleate; phenol; benzoic acid; hydroquinone; ethyl 2-hydroxyacetate; and proline. Examples of the sulfur compound are a disulfide and thiophenol.

A polar monomer in the present invention contains an addition polymerizable carbon-to-carbon double bond, and is preferably a polar monomer having 2 to 20 carbon atoms, which may be cyclic or linear. Said carbon-to-carbon double bond may be conjugated directly with a hetero atom-containing functional group such as a carbonyl group in an acrylic ester and a nitrile group in acrylonitrile, and may be linked directly with a hetero atom such as an oxygen atom in vinyl acetate. The polar monomer may further contain a group (for example, a carbonyl group, a cyano group, an amino group, a hydroxyl group and a halogeno group) or a linkage (for example, an ether linkage), which have no direct conjugation or linkage with said carbon-to carbon double bond.

Examples of the above-mentioned unsaturated carboxylic acid as the polar monomer are acrylic acid and methacrylic acid.

Examples of the above-mentioned unsaturated carboxylic ester as the polar monomer are an alkyl ester of acrylic acid such as methyl acrylate, ethyl acrylate, n-propyl acrylate, isopropyl acrylate, n-butyl acrylate, isobutyl acrylate, sec-butyl acrylate, tert-butyl acrylate, n-pentyl acrylate, isopentyl acrylate, sec-pentyl acrylate, tert-pentyl acrylate, neopentyl acrylate, cyclopentyl acrylate, n-hexyl acrylate, cyclohexyl acrylate, n-heptyl acrylate, n-octyl acrylate, 2-ethylhexyl acrylate, nonyl acrylate, decyl acrylate, dodecyl acrylate, isobornyl acrylate, dicyclopentyl acrylate, menthyl acrylate, noradamantyl acrylate and adamantyl acrylate; an aryl ester of acrylic acid such as phenyl acrylate, toluoyl acrylate and benzyl acrylate; an acrylic ester such as 2-methoxyethyl acrylate, 3-methoxybutyl acrylate, 2-hydroxyethyl acrylate, 2-hydroxypropyl acrylate, stearyl acrylate, glycidyl acrylate, 2-aminoethyl acrylate, γ-(acryloyloxypropyl)trimethoxysilane, γ-(acryloyloxypropyl)dimethoxymethylsilane, trifluoromethylmethyl acrylate, 2-trifluoromethylethyl acrylate, 2-perfluoroethylethyl acrylate, 2-perfluoroethyl-2-perfluorobutylethyl acrylate, 2-perfluoroethyl acrylate, perfluoromethyl acrylate, diperfluoromethylmethyl acrylate, 2-perfluoromethyl-2-perfluoroethylmethyl acrylate, 2-perfluorohexylethyl acrylate, 2-perfluorodecylethyl acrylate, and 2-perfluorohexadecylethyl acrylate; an alkyl ester of methacrylic acid such a methacrylic ester such as methyl methacrylate, ethyl methacrylate, n-propyl methacrylate, isopropyl methacrylate, n-butyl methacrylate, isobutyl methacrylate, sec-butyl methacrylate, tert-butyl methacrylate, n-pentyl methacrylate, isopentyl methacrylate, sec-pentyl methacrylate, tert-pentyl methacrylate, neopentyl methacrylate, cyclopentyl methacrylate, n-hexyl methacrylate, cyclohexyl methacrylate, n-heptyl methacrylate, n-octyl methacrylate, 2-ethylhexyl methacrylate, nonyl methacrylate, decyl methacrylate, dodecyl methacrylate, isobornyl methacrylate, dicyclopentyl methacrylate, menthyl methacrylate, noradamantyl methacrylate and adamantyl methacrylate; an aryl ester of methacrylic acid such as phenyl methacrylate, toluoyl methacrylate and benzyl methacrylate; and a methacrylic ester such as 2-methoxyethyl methacrylate, 3-methoxybutyl methacrylate, 2-hydroxyethyl methacrylate, 2-hydroxypropyl methacrylate, stearyl methacrylate, glycidyl methacrylate, 2-aminoethyl methacrylate, γ-(methacryloyloxypropyl)trimethoxysilane, γ-(methacryloyloxypropyl)dimethoxymethylsilane, trifluoromethylmethyl methacrylate, 2-trifluoromethylethyl methacrylate, 2-perfluoroethylethyl methacrylate, 2-perfluoroethyl-2-perfluorobutylethyl methacrylate, 2-perfluoroethyl methacrylate, perfluoromethyl methacrylate, diperfluoromethylmethyl methacrylate, 2-perfluoromethyl-2-perfluoroethylmethyl methacrylate, 2-perfluorohexylethyl methacrylate, 2-perfluorodecylethyl methacrylate, and 2-perfluorohexadecylethyl methacrylate. Among them, preferred is an alkyl ester of acrylic acid or an alkyl ester of methacrylic acid, and more preferred is methyl acrylate or methyl methacrylate.

Examples of the above-mentioned unsaturated carboxylic amide as the polar monomer are N-methylacrylamide, N-ethylacrylamide, N-isopropylacrylamide, N-phenylacrylamide, N,N-dimethylacrylamide, N,N-diethylacrylamide, N,N-diphenylacrylamide, N-methylmethacrylamide, N-ethylmethacrylamide, N-phenylmethacrylamide, N-isopropylmethacrylamide, N,N-dimethylmethacrylamide, N,N-diethylmethacrylamide, and N,N-diphenylmethacrylamide.

Examples of the above-mentioned vinyl ether as the polar monomer are methyl vinyl ether, ethyl vinyl ether, phenyl vinyl ether, and propyl vinyl ether.

Examples of the above-mentioned vinyl ester as the polar monomer are vinyl acetate, vinyl propionate, vinyl butyrate, vinyl valerate, and vinyl isovalerate.

Examples of the above-mentioned unsaturated nitrile as the polar monomer are acrylonitrile and methacrylonitrile.

Examples of the above-mentioned unsaturated aldehyde as the polar monomer are acrolein and methacrolein.

Examples of the above-mentioned unsaturated ketone as the polar monomer are methyl vinyl ketone, ethyl vinyl ketone, phenyl vinyl ketone, and propyl vinyl ketone.

An olefin in the present invention contains an addition polymerizable carbon-to-carbon double bond, and is preferably an olefin having 2 to 20 carbon atoms, which may be a cyclic olefin or a linear olefin. Said carbon-to-carbon double bond is not conjugated with a hetero atom-containing functional group such as a carbonyl group in an unsaturated carboxylic ester and a nitrile group in an unsaturated nitrile, and is not linked directly with a hetero atom such as an oxygen atom in a vinyl ether (CH₂═CH—O—), a nitrogen atom and a sulfur atom. The olefin may further contain a group (for example, a carbonyl group, a cyano group, an amino group, a hydroxyl group and a halogeno group) or a linkage (for example, an ether linkage), which have no conjugation or no direct linkage with said carbon-to carbon double bond. The olefin may be used in combination of two or more kinds thereof in the process for producing a polymer of the present invention.

Examples of the olefin are an alkene, a vinyl aromatic compound, a diene, a carbonyl group-containing olefin, a cyano group-containing olefin, an amino group-containing olefin, a hydroxyl group-containing olefin, a halogeno group-containing olefin, and an ether linkage-containing olefin.

The above-mentioned alkene means an olefin containing an addition polymerizable carbon-to-carbon double bond. Examples of the alkene are ethylene; an α-olefin such as propylene, 1-butene, 2-butene, 1-pentene, 2-pentene, 1-hexene, 2-hexene, 3-hexene, neohexene, 3-methyl-1-pentene, 3-ethyl-1-pentene, 4-methyl-1-pentene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 2-heptene, 2-octene, 2-nonene, 2-decene, 2-undecene, 2-dodecene, 2-tridecene, 2-tetradecene, 2-pentadecene, 2-hexadecene, 2-heptadecene, 2-octadecene, 2-nonadecene, 2-eicosene, 3-heptene, 3-octene, 3-nonene, 3-decene, 3-undecene, 3-dodecene, 3-tridecene, 3-tetradecene, 3-pentadecene, 3-hexadecene, 3-heptadecene, 3-octadecene, 3-nonadecene, 3-eicosene, 2-methyl-1-hexene, 2-methyl-1-heptene, 2-methyl-1-octene, 2-methyl-1-nonene, 2-methyl-1-decene, 2-methyl-1-undecene, 2-methyl-1-dodecene, 2-methyl-1-tridecene, 2-methyl-1-tetradecene, 2-methyl-1-pentadecene, 2-methyl-1-hexadecene, 2-methyl-1-heptadecene, 2-methyl-1-octadecene, 2-methyl-1-nonadecene, 2-methyl-1-eicosene, 2-methyl-2-heptene, 2-methyl-2-octene, 2-methyl-2-nonene, 2-methyl-2-decene, 2-methyl-2-undecene, 2-methyl-2-dodecene, 2-methyl-2-tridecene, 2-methyl-2-tetradecene, 2-methyl-2-pentadecene, 2-methyl-2-hexadecene, 2-methyl-2-heptadecene, 2-methyl-2-octadecene, 2-methyl-2-nonadecene, 2-methyl-2-eicosene, 2-methyl-3-heptene, 2-methyl-3-octene, 2-methyl-3-nonene, 2-methyl-3-decene, 2-methyl-3-undecene, 2-methyl-3-dodecene, 2-methyl-3-tridecene, 2-methyl-3-tetradecene, 2-methyl-3-pentadecene, 2-methyl-3-hexadecene, 2-methyl-3-heptadecene, 2-methyl-3-octadecene, 2-methyl-3-nonadecene, 2-methyl-3-eicosene, 3-methyl-1-hexene, 3-methyl-1-heptene, 3-methyl-1-octene, 3-methyl-1-nonene, 3-methyl-1-decene, 3-methyl-1-undecene, 3-methyl-1-dodecene, 3-methyl-1-tridecene, 3-methyl-1-tetradecene, 3-methyl-1-pentadecene, 3-methyl-1-hexadecene, 3-methyl-1-heptadecene, 3-methyl-1-octadecene, 3-methyl-1-nonadecene, 3-methyl-1-eicosene, 3-methyl-2-heptene, 3-methyl-2-octene, 3-methyl-2-nonene, 3-methyl-2-decene, 3-methyl-2-undecene, 3-methyl-2-dodecene, 3-methyl-2-tridecene, 3-methyl-2-tetradecene, 3-methyl-2-pentadecene, 3-methyl-2-hexadecene, 3-methyl-2-heptadecene, 3-methyl-2-octadecene, 3-methyl-2-nonadecene, 3-methyl-2-eicosene, 3-methyl-3-heptene, 3-methyl-3-octene, 3-methyl-3-nonene, 3-methyl-3-decene, 3-methyl-3-undecene, 3-methyl-3-dodecene, 3-methyl-3-tridecene, 3-methyl-3-tetradecene, 3-methyl-3-pentadecene, 3-methyl-3-hexadecene, 3-methyl-3-heptadecene, 3-methyl-3-octadecene, 3-methyl-3-nonadecene, 3-methyl-3-eicosene, vinylcyclohexane, isobutene, 2-methyl-1-butene, 2-methyl-2-butene, 2-ethyl-1-pentene, 2-methyl-1-pentene, and 2,4,4-trimethyl-1-pentene; cyclopentene; cyclobutene; cyclohexene; cycloheptene; cyclooctene; cyclononene; cyclodecene; norbornene; methylidenecyclohexane; ethylidenecyclohexane; limonene; pinene; carene; and camphene.

The above-mentioned vinyl aromatic compound may further contain a group (for example, a carbonyl group, a cyano group, an amino group and a halogeno group) or a linkage (for example, an ether linkage) as long as its carbon-to-carbon double bond conjugates with its aromatic ring. Said aromatic ring may be a hydrocarbyl aromatic ring or a heteroaromatic ring. The vinyl aromatic compound may be used in combination of two or more kinds thereof in the process for producing a polymer of the present invention. Examples of the vinyl aromatic compound are styrene, 4-bromostyrene, 2,4-dibromostyrene, 3,5-dibromostyrene, 3,4,5-tribromostyrene, 2,4,6-tribromostyrene, 2,3,4,5,6-pentabromostyrene, 3-bromostyrene, 2-bromostyrene, 4-chlorostyrene, 3-chlorostyrene, 2-chlorostyrene, 4-fluorostyrene, 3-fluorostyrene, 2-fluorostyrene, 2,3,4,5,6-pentafluorostyrene, 4-methoxystyrene, 2,4-dimethoxystyrene, 3,5-dimethoxystyrene, 3,4,5-trimethoxystyrene, 2,4,6-trimethoxystyrene, 2,3,4,5,6-pentamethoxystyrene, 3-methoxystyrene, 2-methoxystyrene, 4-vinylbezoic acid, 3-vinylbezoic acid, 2-vinylbezoic acid, methyl 4-vinylbezoate, methyl 3-vinylbezoate, methyl 2-vinylbezoate, 4-cyanostyrene, 2,4-dicyanostyrene, 3,5-dicyanostyrene, 3-cyanostyrene, 2-cyanostyrene, 4-aminostyrene, 3,5-diaminostyrene, 4-(N,N-dimethylamino)styrene, 2-vinylpyridine, 3-vinylpyridine, 4-vinylpyridine, 2,6-di-tert-butyl-4-vinylpyridine, 1-vinylnaphthalene, 2-vinylnaphthalene, 1-vinylanthracene, 2-vinylanthracene, and 9-vinylanthracene.

The above-mentioned diene is an olefin containing a diene structure in its molecule. Examples of the diene are a linear compound such as butadiene, isoprene, 2-methoxybutadiene, 2-trimethylsiloxybutadiene, 2,3-dimethylbutadiene, 1,3-pentadiene, 1,3-hexadiene, and 2,4-hexadiene; and a cyclic compound such as cyclopentadiene, cyclohexadiene, 2-trimethylsiloxy-1,3-cyclohexadiene, 1,3-cycloheptadiene, 1,3-cyclooctadiene, furane, 2H-pyrane, pyrrole, and thiophene.

Examples of the above-mentioned carbonyl group-containing olefin are allyl acetate, β-vinyl-γ-lactone, methyl allyl ketone, allyl aldehyde, allylamide, N-acetylallylamide, and N-allylacetamide.

An example of the above-mentioned cyano group-containing olefin is 3-propen-1-nitrile.

An example of the above-mentioned amino group-containing olefin is allylamine.

Examples of the above-mentioned hydroxyl group-containing olefin are allyl alcohol and homoallyl alcohol.

An example of the above-mentioned halogeno group-containing olefin is allyl chloride.

Examples of the above-mentioned ether linkage-containing olefin are methyl ally ether, phenyl ally ether, ally glycidyl ether, and limonene oxide.

A polymer in the present invention is (i) a homopolymer of a polar monomer, (ii) a copolymer of two or more kinds of polar monomers, (iii) a copolymer of at least one kind of an olefin and at least one kind of a polar monomer, (iv) a homopolymer of an olefin, or (v) a copolymer of two or more kinds of olefins.

Examples of the above-mentioned homopolymer (i) are a homopolymer of an acrylic ester, a homopolymer of a methacrylic ester, a homopolymer of an unsaturated carboxylic acid, a homopolymer of an unsaturated carboxylic amide, a homopolymer of a vinyl ether, a homopolymer of a vinyl ester, a homopolymer of an unsaturated nitrile, a homopolymer of an unsaturated aldehyde, and a homopolymer of an unsaturated ketone. Among them, preferred is a homopolymer of an acrylic ester, or a homopolymer of a methacrylic ester.

Examples of the above-mentioned copolymer (ii) are a copolymer of an acrylic ester and a methacrylic ester, a copolymer of an acrylic ester and a vinyl ester, a copolymer of an unsaturated nitrile and a vinyl ester, a copolymer of an unsaturated nitrile and an acrylic ester, a copolymer of an unsaturated nitrile and a methacrylic ester, a copolymer of an unsaturated nitrile, an acrylic ester and a methacrylic ester, a copolymer of an unsaturated nitrile, a methacrylic ester and a vinyl ester, and a copolymer of an unsaturated nitrile, an acrylic ester, a methacrylic ester and a vinyl ester. Among them, preferred is a copolymer obtained by using an acrylic ester and/or a methacrylic ester as a comonomer.

Examples of the above-mentioned copolymer (iii) are a copolymer of an acrylic ester and an alkene, a copolymer of a methacrylic ester and an alkene, a copolymer of an acrylic ester and a vinyl aromatic compound, a copolymer of a methacrylic ester and a vinyl aromatic compound, a copolymer of an acrylic ester and a diene, a copolymer of a methacrylic ester and a diene, a copolymer of an acrylic ester, an alkene and a diene, a copolymer of a methacrylic ester, an alkene and a diene, a copolymer of an acrylic ester, a vinyl aromatic compound and a diene, a copolymer of a methacrylic ester, a vinyl aromatic compound and a diene, a copolymer of an unsaturated nitrile and an alkene, a copolymer of an unsaturated nitrile and a vinyl aromatic compound, a copolymer of an unsaturated nitrile and a diene, a copolymer of an unsaturated nitrile, a vinyl aromatic compound and a diene, a copolymer of an acrylic ester, an unsaturated nitrile, a vinyl aromatic compound and a diene, a copolymer of a methacrylic ester, an unsaturated nitrile, a vinyl aromatic compound and a diene, a copolymer of a vinyl ester and an alkene, a copolymer of a vinyl ester and a diene, a copolymer of a vinyl ester and a vinyl aromatic compound, a copolymer of an acrylic ester, a vinyl ester and a vinyl aromatic compound, a copolymer of a methacrylic ester, a vinyl ester and a vinyl aromatic compound, and a copolymer of an unsaturated nitrile, a vinyl ester and a vinyl aromatic compound. Among them, preferred is a copolymer of an acrylic ester and an alkene or a copolymer of a methacrylic ester and an alkene, and more preferred is a copolymer of an acrylic ester and ethylene, a copolymer of a methacrylic ester and ethylene, a copolymer of an acrylic ester, ethylene, and propylene, a copolymer of a methacrylic ester, ethylene and propylene, a copolymer of an acrylic ester, a methacrylic ester and ethylene, or a copolymer of an acrylic ester, a methacrylic ester, ethylene and propylene.

Examples of the above-mentioned homopolymer (iv) are a homopolymer of an alkene, a homopolymer of a diene, and a homopolymer of vinyl aromatic compound. Among them, preferred is a homopolymer of an alkene, more preferred is a homopolymer of an α-olefin, and further preferred is a homopolymer of ethylene.

Examples of the above-mentioned copolymer (v) are a copolymer of an alkene and a diene, and a copolymer of a vinyl aromatic compound and a diene.

A weight average molecular weight (Mw) and a number average molecular weight (Mn) of a polymer in the present invention are not particularly limited, and the weight average molecular weight is preferably 10,000 to 2,000,000 in order to improve processability of said polymer and decrease an amount of a low molecular weight component contained in said polymer.

A molecular weight distribution of a polymer in the present invention, which is represented by a ratio of the above-mentioned Mw to the above-mentioned Mn, is not particularly limited, and is preferably 1.0 to 8.0, more preferably 1.0 to 4.0, and further preferably 1.0 to 2.0 in order to improve processability of said polymer and decrease an amount of a low molecular weight component contained in said polymer.

In the process for producing a polymer of the present invention, the transition metal compound is used in a concentration of usually 0.01 to 100 mmol/L, and preferably 0.1 to 40 mmol/L, and the halogen-containing organic compound is used in a concentration of usually 0.1 to 200 mmol/L, and preferably 0.5 to 80 mmol/L, each of which is a concentration of the transition metal compound or the halogen-containing organic compound in a polymerization medium.

The above-mentioned compound containing the group 3, 13, 15 or 16 atom is used in a suitably controlled amount, and said amount is preferably 0.5 to 1.000 mmol/L, and more preferably 1 to 500 mmol/L, which is a concentration of the compound containing the group 3, 13, 15 or 16 atom in a polymerization medium.

While polymerization temperature in the process for producing a polymer of the present invention is not particularly limited, too low polymerization temperature may result in inhibition of a polymerization reaction, and too high polymerization temperature may result in decrease of a polymerization activity. Therefore, it is preferably 20 to 250° C., and more preferably 40 to 200° C.

Polymerization pressure in the process for producing a polymer of the present invention is not particularly limited, and when using ethylene as the olefin, it is usually 0.1 to 300 MPa.

A polymerization time in the process for producing a polymer of the present invention can generally be suitably selected according to a kind of a target polymer or a type of a polymerization reactor, and is usually 15 seconds to 40 hours starting on a point of arriving of polymerization conditions at target ones.

A polymerization form in the process for producing a polymer of the present invention is not particularly limited, and examples thereof are a continuous polymerization form, and a batch-wise polymerization form.

A polymerization method in the process for producing a polymer of the present invention is not particularly limited, and examples thereof are a bulk polymerization method, a solution polymerization method, and a slurry polymerization method. Examples of a solvent used in the latter two methods are an aliphatic hydrocarbon solvent such as propane, pentane, hexane, heptane, octane, petroleum ether, and liquid paraffin; an aromatic hydrocarbon solvent such as benzene, toluene and xylene; an ether solvent such as diethyl ether, tetrahydrofuran, methyl tert-butyl ether, 1,3-dioxane, and 1,4-dioxane; a carbonyl group-containing solvent such as ethyl acetate, methyl acetate, N-methylpyrrolidone, dimethylformamide, dimethylacetamide, acetone, methyl ethyl ketone, and diethyl ketone; a protonic solvent such as methanol, ethanol, isopropanol, butanol, acetic acid, trifluoroacetic acid, and water; and a combination of two or more thereof.

In the process for producing a polymer of the present invention, a chain-transfer agent may be used in order to regulate a molecular weight of a target polymer.

When homopolymerizing an alkene (for example, homopolymerizing an ethylene) or copolymerizing an alkene (for example, copolymerizing a large amount of ethylene with a small amount of propylene) in the process for producing a polymer of the present invention, a polymerization method is preferably a bulk polymerization method, or a solution polymerization method carried out under a polymerization pressure of 4 MPa or higher. For example, when homopolymerizing ethylene by a bulk polymerization method, or copolymerizing 80% by mol or larger of ethylene with 20% by mol or smaller of propylene by a bulk polymerization method (the total thereof being 100% by mol), polymerization pressure is preferably 50 MPa or higher, and more preferably 100 MPa or higher, and polymerization temperature is preferably 80° C. or higher, and more preferably 120° C. or higher, which is referred to as “high pressure bulk polymerization”.

When copolymerizing a polar monomer with an olefin (for example, with ethylene, or with a combination of a large amount of ethylene with a small amount of propylene) in the process for producing a polymer of the present invention, a polymerization method is preferably a bulk polymerization method, or a solution polymerization method carried out under a polymerization pressure of 1 MPa or higher. For example, when copolymerizing a polar monomer with ethylene by a bulk polymerization method, or copolymerizing a polar monomer with a combination of 80% by mol or larger of ethylene with 20% by mol or smaller of propylene by a bulk polymerization method (the total thereof being 100% by mol), polymerization pressure is preferably 50 MPa or higher, and more preferably 100 MPa or higher, and polymerization temperature is preferably 80 or higher, and more preferably 120% or higher, which is referred to as “high pressure bulk polymerization”.

The polymerizing step of the process for producing a polymer of the present invention may be a multiple-stage polymerizing step, which means a polymerizing step having one or more changeover times of polymerization conditions. The number of the changeover times is preferably one to three times from a viewpoint of a balance of characteristics required for a target polymer and an economic efficiency of the process. An amount of a monomer polymerized in each polymerization step is preferably 10% by mole or larger, and more preferably 25% by mole or larger so that respective polymers produced in respective polymerization steps have different structures from one another, wherein the total amount of the monomer contained in a polymerization medium existing in each polymerization step is 100% by mole.

A method of the above-mentioned changeover is not particularly limited. Examples thereof are (1) a method comprising the step of continuously changing over the polymerization conditions under continuation of polymerization, and (2) a method comprising the steps of (2-1) removing volatile components from a polymerization reaction mixture, and then (2-2) feeding an additional monomer.

A polymerization time in each polymerization stage of the above-mentioned multiple-stage polymerizing step can generally be selected suitably according to a kind of a target polymer or a type of a polymerization reactor. Said time is usually 5 seconds to 24 hours starting on a point of arriving of polymerization conditions at target ones, and preferably 5 seconds to 1 hour from an economical point of view.

An average molecular weight of a polymer obtained by the multiple-stage polymerizing step is not particularly limited. Its weight average molecular weight is preferably 10,000 to 2,000,000 in order to improve processability of said polymer and decrease an amount of a low molecular weight component contained in said polymer. Its molecular weight distribution is not also particularly limited, and is preferably 1.0 to 6.0, more preferably 1.0 to 4.0, and further preferably 1.0 to 2.0 in order to improve processability of said polymer and decrease an amount of a low molecular weight component contained in said polymer.

In the multiple-stage polymerizing step, the transition metal compound is used in a concentration of usually 0.01 to 100 mmol/L, and preferably 0.1 to 40 mmol/L, and the halogen-containing organic compound is used in a concentration of usually 0.1 to 200 mmol/L, and preferably 0.5 to 80 mmol/L, each of which is a concentration of the transition metal compound or the halogen-containing organic compound in a polymerization medium. The compound containing the group 3, 13, 15 or 16 atom is used in a suitably controlled amount, and said amount is preferably 0.5 to 1.000 mmol/L, and more preferably 1 to 500 mmol/L, which is a concentration of the compound containing the group 3, 13, 15 or 16 atom in a polymerization medium.

While polymerization temperature in the multiple-stage polymerizing step is not particularly limited, too low polymerization temperature may result in inhibition of a polymerization reaction, and too high polymerization temperature may result in decrease of a polymerization activity. Therefore, it is preferably 20 to 250° C., and more preferably 40 to 200° C.

Polymerization pressure in the multiple-stage polymerizing step is not particularly limited, and when using ethylene as the olefin, it is usually 0.1 to 300 MPa.

A polymerization time in the multiple-stage polymerizing step can generally be suitably selected according to a kind of a target polymer or a type of a polymerization reactor, and is usually 15 seconds to 40 hours starting on a point of arriving of polymerization conditions at target ones.

A polymerization form in the multiple-stage polymerizing step is not particularly limited, and examples thereof are a continuous polymerization form, and a batch-wise polymerization form.

A polymerization method in the multiple-stage polymerizing step is not particularly limited, and examples thereof are a solution polymerization method, and a slurry polymerization method. Examples of a solvent used therein are an aliphatic hydrocarbon solvent such as propane, pentane, hexane, heptane and octane; an aromatic hydrocarbon solvent such as benzene, toluene and xylene; an ether solvent such as diethyl ether, tetrahydrofuran, methyl tert-butyl ether, 1,3-dioxane, and 1,4-dioxane; a carbonyl group-containing solvent such as ethyl acetate, methyl acetate, N-methylpyrrolidone, dimethylformamide, dimethylacetamide, acetone, methyl ethyl ketone, and diethyl ketone; a protonic solvent such as methanol, ethanol, isopropanol, butanol, acetic acid, trifluoroacetic acid, and water; and a combination of two or more thereof.

In the multiple-stage polymerizing step, a chain-transfer agent may be used in order to regulate a molecular weight of a target polymer.

According to the present invention, there can be provided (i) a transition metal compound, which has excellent solubility in a solvent, excellent stability during polymerization, and excellent polymerization activity, (ii) a polymerization-initiator system comprising the transition metal compound, and (iii) a process for producing a polymer in the presence of the polymerization-initiator system.

### EXAMPLE

The present invention is explained with reference to the following Examples, which do not limit the scope of the present invention.

### Reference Example 1

### Preparation of Starting Material to Prepare Transition Metal Compound

In a three-necked 2,000 mL glass flask equipped with a reflux tube and a dropping funnel, 58.3 g of a ground magnesium metal was put, and dried sufficiently. A gas in the flask was displaced with a nitrogen gas, and there was put therein 400 mL of purified tetrahydrofuran as a solvent with a syringe at ordinary temperature and atmospheric pressure. There was further added dropwise 192 mL of dodecyl bromide manufactured by Kanto Chemical Co., Inc. with the dropping funnel over one hour to the mixture in the flask cooled with ice, and then, the reaction was continued for two hours under the cooling with ice. To the obtained mixture cooled with ice, 120.6 mL of 2,3,4,5-tetramethyl-2-cyclopenten-1-one manufactured by Kanto Chemical Co., Inc. and 100 mL of purified tetrahydrofuran as a solvent were added dropwise over one hour with the dropping funnel, and then, the reaction was continued for fifteen hours while raising gradually the temperature of the mixture in the flask up to room temperature. After completion of the reaction, 100 mL of tetrahydrofuran was added thereto, and then, 300 mL of a hydrochloric acid having a concentration of 0.5 mol/L was added gradually to the mixture under cooling said mixture with ice in order to inhibit a sudden reaction. The organic and water layers thereof were separated from each other, and the organic layer was washed with 200 mL of water. The solvent contained in the washed layer was distilled away under reduced pressure, thereby obtaining an organic component.

The organic component was added dropwise with a dropping funnel to 1.0 L of hot water boiling at 60 to 80° C. under a reduced pressure, thereby azeotropically distilling away unreacted materials together with water. When an amount of the distillate was over 500 mL, the azeotropic distillation was stopped, and 500 mL of water was further added thereto, and the azeotropic distillation was started again, thereby obtaining the remaining organic component.

The remaining organic component was mixed with 50 mL of saturated brine, and the organic and water layers thereof were separated from each other. The organic layer was dried over anhydrous magnesium sulfate. The mixture was filtered, and the separated solid containing mainly the above-mentioned magnesium sulfate was washed with hexane. The solvent contained in the hexane solution was distilled away under reduced pressure, said hexane solution being a combination of (1) the filtrate obtained in the above-mentioned filtration with (2) hexane obtained in the above-mentioned washing with hexane. The remainder was dried at 40° C. for two hours under reduced pressure, thereby obtaining 228 g of dodecyl(tetramethyl)cyclopentadiene.

Gas chromatography analysis showed that purity of the obtained dodecyl(tetramethyl)cyclopentadiene was 64% by weight.

¹H NMR analysis thereof showed: 0.83 to 0.89 ppm (the terminal methyl group in the alkyl chain), 0.95 to 1.02 ppm (the methyl group), 1.15 to 1.45 ppm (the methylene in the alkyl chain), 1.05 to 1.90 ppm (the methyl group), 2.00 to 2.36 ppm (the base methylene in the alkyl chain), and 2.40 to 2.67 ppm (the methyne on the 5-membered ring).

The above-mentioned gas chromatography analysis was conducted under the following conditions:

measuring instrument: GC-17A manufactured by Shimadzu Corporation,

column temperature: 100° C. up to 300° C. at a temperature-raising rate of 5° C./minute,

column: DB-5MS having a length of 30 m, a radius of 0.25 mm, and a wall-thickness of 1 μm, and

sample concentration: 0.05 mL/mL.

The above-mentioned ¹H NMR analysis and the below-mentioned ¹³C NMR analysis were conducted under the following conditions:

measuring instrument: 400 MHz NMR manufactured by JEOL LTD,

measuring temperature: 23° C.,

solvent: chloroform-d (for analysis of the polymer, and for ligand analysis of the transition metal compound), and toluene-d₈ (for analysis of the transition metal compound), and

sample concentration: 20 mg/mL.

### Reference Example 2

### Preparation of Transition Metal Compound

A two-necked 1,000 mL glass flask equipped with a reflux tube was dried sufficiently, and a gas in the flask was displaced with a nitrogen gas. There were put in the flask, at ordinary temperature and atmospheric pressure, using a syringe, 209 g of dodecyl(tetramethyl)cyclopentadiene (purity: 64% by weight) obtained in Reference Example 1, 198 mL of iron pentacarbonyl manufactured by Kanto Chemical Co., Inc., and 100 mL of purified toluene as a solvent, and the mixture was refluxed at 110° C. for 48 hours. The solvent contained in the reaction mixture was distilled away under reduced pressure. Hexane was added to the remainder, and the mixture was heated up to 40° C., thereby dissolving a solid in said mixture. The mixture was filtered with celite under a nitrogen atmosphere, and a separated solid on celite (said solid containing iron powder resulted from iron pentacarbonyl) was washed with hexane. The solvent contained in the hexane solution was distilled away under reduced pressure, said hexane solution being a combination of (1) the filtrate obtained in the above-mentioned filtration with (2) hexane obtained in the above-mentioned washing with hexane. The remainder was cooled with ice, thereby precipitating a solid. The solid was filtered off, and dried for three hours under reduced pressure at room temperature, thereby obtaining 137 g of [dodecyl(tetramethyl)cyclopentadienyl]iron carbonyl dimer (transition metal compound).

¹H NMR analysis thereof showed: 0.92 ppm (3H, the terminal methyl group in the alkyl chain), 1.27 ppm (20H, the methylene in the alkyl chain), 1.61 ppm (6H, the methyl group), 1.80 ppm (6H, the methyl group), and 2.36 ppm (2H, the base methylene in the alkyl chain).

¹³C NMR analysis thereof showed: 8.6 ppm and 8.8 ppm (the methyl group), 14.4 ppm (the terminal methyl group in the alkyl chain), 23.2 ppm, 24.6 ppm, 29.9 ppm, 30.0 ppm, 30.1 ppm, 30.2 ppm, 30.3 ppm, 30.4 ppm and 32.4 pppm (the alkyl group), and 97.2 ppm, 98.7 ppm and 102.1 ppm (the quaternary carbon atom on the 5-membered ring).

### Reference Example 3

### Preparation of Transition Metal Compound

Reference Example 2 was repeated except that (i) 209 g of dodecyl(tetramethyl)cyclopentadiene (purity: 64% by weight) was changed to 20 g of octyl(tetramethyl)cyclopentadiene (purity: 0.87% by weight) prepared according to a method similarly to that in Reference Example 1, using octyl bromide instead of dodecyl bromide, (ii) an amount of iron pentacarbonyl was changed to 30 mL, and (iii) an amount of purified toluene as a solvent was changed to 48 mL, thereby obtaining 13 g of [octyl(tetramethyl)cyclopentadienyl]iron carbonyl dimer (transition metal compound).

### Example 1

There was dissolved [dodecyl(tetramethyl)cyclopentadienyl]iron carbonyl dimer (transition metal compound) obtained in Reference Example 2 in 30 mL of hexane (solvent), and the solution was heated up to 40° C. It was confirmed that the solution contained a small excess amount of said transition metal compound insoluble at that temperature, and the solution was allowed to stand for three hours at room temperature (23° C.). The supernatant solution thereof was filtered with a TEFLON filter (φ: 0.45 μm). Hexane (solvent) contained in 10 mL of the filtrate was distilled away, and the remainder was vacuum-dried, thereby obtaining a solid of said transition metal compound. An amount of said solid, namely, 131.4 mmol of said transition metal compound, was assigned to be a saturated solubility of said transition metal compound in hexane at 23° C., namely, said transition metal compound had excellent solubility in hexane. Results are shown in Table 1.

### Example 2

Example 1 was repeated except that the solvent was changed to toluene, thereby obtaining a saturated solubility of 184.1 mmol of said transition metal compound in toluene at 23° C., namely, said transition metal compound had excellent solubility in toluene. Results are shown in Table 1.

### Example 3

Example 1 was repeated except that the transition metal compound was changed to [octyl(tetramethyl)cyclopentadienyl]iron carbonyl dimer obtained in Reference Example 3, thereby obtaining a saturated solubility of 96.8 mmol of said transition metal compound in hexane at 23° C., namely, said transition metal compound had excellent solubility in hexane. Results are shown in Table 1.

### Example 4

Example 3 was repeated except that the solvent was changed to toluene, thereby obtaining a saturated solubility of 182.7 mmol of said transition metal compound in toluene at 23° C., namely, said transition metal compound had excellent solubility in toluene. Results are shown in Table 1.

### Comparative Example 1

Example 1 was repeated except that the transition metal compound was changed to (cyclopentadienyl)iron carbonyl dimer manufactured by Strem Chemical Inc., thereby obtaining a saturated solubility of 2.4 mmol of said transition metal compound in hexane at 23° C. Results are shown in Table 1.

### Comparative Example 2

Comparative Example 1 was repeated except that the solvent was changed to toluene, thereby obtaining a saturated solubility of 167.3 mmol of said transition metal compound in toluene at 23° C. Results are shown in Table 1.

### Comparative Example 3

Example 1 was repeated except that the transition metal compound was changed to [(pentamethyl)cyclopentadienyl]iron carbonyl dimer manufactured by Strem Chemical Inc., thereby obtaining a saturated solubility of 0.8 mmol of said transition metal compound in hexane at 23° C. Results are shown in Table 1.

### Comparative Example 4

Comparative Example 3 was repeated except that the solvent was changed to toluene, thereby obtaining a saturated solubility of 19.3 mmol of said transition metal compound in toluene at 23° C. Results are shown in Table 1.

### Example 5

A 100 mL glass tube was dried sufficiently, and a gas in the tube was displaced with a nitrogen gas. There were put in the tube, at ordinary temperature and atmospheric pressure, using a syringe, 8.6 mL of butyl acrylate manufactured by Kanto Chemical Co., Inc., and 0.3 mL of purified toluene as a polymerization solvent. Then, 161 mg of [dodecyl(tetramethyl)cyclopentadienyl]iron carbonyl dimer (transition metal compound) obtained in Reference Example 2, and 1.0 mL of a toluene solution of ethyl 2-iodoacetate (manufactured by Aldrich) having a concentration of 0.2 mol/L were put in the tube in this order, thereby polymerizing butyl acrylate at 20° C. for two hours. The polymerization reaction mixture was subjected to distillation under reduced pressure to distil away the remaining monomer (butyl acrylate) and the solvent (toluene).

The resultant solid was dried for three hours in a vacuum dryer (80° C.), thereby obtaining 0.35 g of poly(butyl acrylate).

Said polymer had a weight average molecular weight (Mw) of 92,000 and a number average molecular weight (Mn) of 66,000, in terms of a molecular weight of polystyrene. Its molecular weight distribution (Mw/Mn) of 1.4 was a single peak distribution.

Results are shown in Table 2.

The above-mentioned Mw, Mn and Mw/Mn were measured by GPC (gel permeation chromatography) with a calibration curve made using standard polystyrenes under the following conditions:

measuring apparatus: LC-2000 PLUS series manufactured by JASCO Corporation,

column: Shodex KF-804,

measuring temperature: 40° C.,

solvent: chloroform, and

sample concentration: 5 mg/mL.

### Comparative Example 5

Example 5 was repeated except that the transition metal compound was changed to 99 mg of [(pentamethyl)cyclopentadienyl]iron carbonyl dimer, thereby obtaining 0.08 g of poly(butyl acrylate). Results are shown in Table 2.

### Example 6

A 100 mL glass tube was dried sufficiently, and a gas in the tube was displaced with a nitrogen gas. There were put in the tube, at ordinary temperature and atmospheric pressure, using a syringe, 4.3 mL of butyl acrylate manufactured by Kanto Chemical Co., Inc., and 0.3 mL of purified hexane as a polymerization solvent. Then, 161 mg of [dodecyl(tetramethyl)cyclopentadienyl]iron carbonyl dimer (transition metal compound) obtained in Reference Example 2, and 1.0 mL of a toluene solution of ethyl 2-iodoacetate (manufactured by Aldrich) having a concentration of 0.2 mol/L were put in the tube in this order, thereby polymerizing butyl acrylate at 40° C. for two hours. The polymerization reaction mixture was subjected to distillation under reduced pressure to distil away the remaining monomer (butyl acrylate) and the solvent (hexane). The resultant solid was dried for three hours in a vacuum dryer (80° C.), thereby obtaining 0.21 g of poly(butyl acrylate).

Said polymer had a weight average molecular weight (Mw) of 188,000 and a number average molecular weight (Mn) of 78,100, in terms of a molecular weight of polystyrene. Its molecular weight distribution (Mw/Mn) of 2.4 was a single peak distribution. Results are shown in Table 2.

### Comparative Example 6

Example 6 was repeated except that the transition metal compound was changed to 99 mg of [(pentamethyl)cyclopentadienyl]iron carbonyl dimer, thereby obtaining no polymer. Results are shown in Table 2.

### Example 7

A 100 mL glass tube was dried sufficiently, and a gas in the tube was displaced with a nitrogen gas. There were put in the tube, at ordinary temperature and atmospheric pressure, using a syringe, 8.6 mL of butyl acrylate manufactured by Kanto Chemical Co., Inc., and 0.3 mL of purified toluene as a polymerization solvent. Then, 161 mg of [dodecyl(tetramethyl)cyclopentadienyl]iron carbonyl dimer (transition metal compound) obtained in Reference Example 2, and 1.0 mL of a toluene solution of ethyl 2-iodoacetate (manufactured by Aldrich) having a concentration of 0.2 mol/L were put in the tube in this order, thereby polymerizing butyl acrylate at 40° C. for two hours. The polymerization reaction mixture was subjected to distillation under reduced pressure to distil away the remaining monomer (butyl acrylate) and the solvent (toluene).

The resultant solid was dried for three hours in a vacuum dryer (80° C.), thereby obtaining 4.03 g of poly(butyl acrylate).

Said polymer had a weight average molecular weight (Mw) of 704,000 and a number average molecular weight (Mn) of 7,800, in terms of a molecular weight of polystyrene. Its molecular weight distribution (Mw/Mn) of 7.2 was a single peak distribution. Results are shown in Table 3.

### Comparative Example 7

Example 7 was repeated except that the transition metal compound was changed to 99 mg of [(pentamethyl)cyclopentadienyl]iron carbonyl dimer, thereby obtaining 1.58 g of poly(butyl acrylate).

Said polymer had a weight average molecular weight (Mw) of 646,000 and a number average molecular weight (Mn) of 107,000, in terms of a molecular weight of polystyrene. Its molecular weight distribution (Mw/Mn) of 6.1 was a single peak distribution. Results are shown in Table 3.

### Example 8

A 100 mL glass tube was dried sufficiently, and a gas in the tube was displaced with a nitrogen gas. There were put in the tube, at ordinary temperature and atmospheric pressure, using a syringe, 8.6 mL of butyl acrylate manufactured by Kanto Chemical Co., Inc., and 0.3 mL of purified toluene as a polymerization solvent. Then, 161 mg of [dodecyl(tetramethyl)cyclopentadienyl]iron carbonyl dimer (transition metal compound) obtained in Reference Example 2, and 1.0 mL of a toluene solution of ethyl 2-iodoacetate (manufactured by Aldrich) having a concentration of 0.2 mol/L were put in the tube in this order, thereby polymerizing butyl acrylate at 60° C. for two hours. The polymerization reaction mixture was subjected to distillation under reduced pressure to distil away the remaining monomer (butyl acrylate) and the solvent (toluene). The resultant solid was dried for three hours in a vacuum dryer (80° C.), thereby obtaining 5.99 g of poly(butyl acrylate).

Said polymer had a weight average molecular weight (Mw) of 611,000 and a number average molecular weight (Mn) of 192,000, in terms of a molecular weight of polystyrene. Its molecular weight distribution (Mw/Mn) of 3.2 was a single peak distribution. When dipping said polymer in heptane, the transition metal compound contained in said polymer was transferred to heptane, and said polymer was decolorized from red to very pale yellow. Results are shown in Table 3.

### Comparative Example 8

Example 8 was repeated except that the transition metal compound was changed to 99 mg of [(pentamethyl)cyclopentadienyl]iron carbonyl dimer, thereby obtaining 1.81 g of poly(butyl acrylate).

Said polymer had a weight average molecular weight (Mw) of 818,000 and a number average molecular weight (Mn) of 209,000, in terms of a molecular weight of polystyrene. Its molecular weight distribution (Mw/Mn) of 3.9 was a single peak distribution. When dipping said polymer in heptane, the transition metal compound contained in said polymer was hardly transferred to heptane, and said polymer remained red and was not decolorized. Results are shown in Table 3.

### Example 9

A 400 mL stainless-steel autoclave was dried sufficiently, and a gas in the autoclave was displaced with a nitrogen gas. There was put in the autoclave, at ordinary temperature and atmospheric pressure, 1.61 g of [dodecyl(tetramethyl)cyclopentadienyl]iron carbonyl dimer (transition metal compound) obtained in Reference Example 2, and then, 18 mL of methyl acrylate manufactured by Tokyo Chemical Industry Co., Ltd. and 18 mL of purified toluene as a polymerization solvent were put therein using a syringe. After heating the mixture up to 150° C., ethylene (olefin) was pressed into the autoclave up to its pressure of 4.0 MPa. Finally, 2.0 mL of a toluene solution of 2-iodobutane (manufactured by Tokyo Chemical Industry Co., Ltd.) having a concentration of 1.0 mol/L was put therein, thereby copolymerizing methyl acrylate and ethylene at 150° C. for 10 minutes. The copolymerization reaction mixture was subjected to distillation under reduced pressure to distil away the remaining monomer (methyl acrylate) and the solvent (toluene). The resultant solid was dried for three hours in a vacuum dryer (80° C.), thereby obtaining 8.7 g of a random copolymer of methyl acrylate and ethylene. Both the original mixture before copolymerization and the copolymerization reaction mixture were red.

Said copolymer had a weight average molecular weight (Mw) of 6,300 and a number average molecular weight (Mn) of 4,500, in terms of a molecular weight of polystyrene. Its molecular weight distribution (Mw/Mn) of 1.4 was a single peak distribution.

Results are shown in Table 4.

### Comparative Example 9

### Comparison with Example 9

A 400 mL stainless-steel autoclave was dried sufficiently, and a gas in the autoclave was displaced with a nitrogen gas. There were put in the autoclave, at ordinary temperature and atmospheric pressure, using a syringe, 18 mL of methyl acrylate manufactured by Tokyo Chemical Industry Co., Ltd., and 60 mL of purified toluene as a polymerization solvent. Then, 20 mL of a toluene solution of (cyclopentadienyl)iron carbonyl dimer (transition metal compound manufactured by Strem Chemical Inc.) having a concentration of 0.1 mol/L was put therein, and the mixture was heated up to 150° C. Ethylene (olefin) was pressed into the autoclave up to its pressure of 4.0 MPa. Finally, 2.0 mL of a toluene solution of ethyl 2-chloropropionate (manufactured by Tokyo Chemical Industry Co., Ltd.) having a concentration of 1.0 mol/L was put in the autoclave, thereby copolymerizing methyl acrylate and ethylene at 150° C. for 30 minutes, the mixture before copolymerization being red. The brownish-red and cloudy copolymerization reaction mixture containing a precipitation was subjected to distillation under reduced pressure to distil away the remaining monomer (methyl acrylate) and the solvent (toluene). The resultant solid was dried for three hours in a vacuum dryer (80° C.), thereby obtaining 0.5 g of a random copolymer of methyl acrylate and ethylene. Results are shown in Table 4.

### Example 10

A 400 mL stainless-steel autoclave was dried sufficiently, and a gas in the autoclave was displaced with a nitrogen gas. There was put in the autoclave, at ordinary temperature and atmospheric pressure, 1.61 g of [dodecyl(tetramethyl)cyclopentadienyl]iron carbonyl dimer (transition metal compound) obtained in Reference Example 2, and then, 18 mL of methyl acrylate manufactured by Tokyo Chemical Industry Co., Ltd. and 60 mL of purified toluene as a polymerization solvent were put therein using a syringe. After heating the mixture up to 180° C., ethylene (olefin) was pressed into the autoclave up to its pressure of 4.0 MPa. Finally, 2.0 mL of a toluene solution of 2-iodobutane (manufactured by Tokyo Chemical Industry Co., Ltd.) having a concentration of 1.0 mol/L was put therein, thereby copolymerizing methyl acrylate and ethylene at 150° C. for 10 minutes. The copolymerization reaction mixture was subjected to distillation under reduced pressure to distil away the remaining monomer (methyl acrylate) and the solvent (toluene). The resultant solid was dried for three hours in a vacuum dryer (80° C.), thereby obtaining 2.6 g of a random copolymer of methyl acrylate and ethylene. Results are shown in Table 4.

### Comparative Example 10

### Comparison with Example 10

A 400 mL stainless-steel autoclave was dried sufficiently, and a gas in the autoclave was displaced with a nitrogen gas. There were put in the autoclave, at ordinary temperature and atmospheric pressure, using a syringe, 18 mL of methyl acrylate manufactured by Tokyo Chemical Industry Co., Ltd., and 60 mL of purified toluene as a polymerization solvent. Then, 0.99 g of [pentamethyl(cyclopentadienyl)]iron carbonyl dimer (transition metal compound manufactured by Strem Chemical Inc.) was put therein, and the mixture was heated up to 150° C. Ethylene (olefin) was pressed into the autoclave up to its pressure of 4.0 MPa. Finally, 1.0 mL of a toluene solution of 2-iodobutane (manufactured by Tokyo Chemical Industry Co., Ltd.) having a concentration of 0.2 mol/L was put therein, thereby copolymerizing methyl acrylate and ethylene at 180° C. for 30 minutes. The copolymerization reaction mixture was subjected to distillation under reduced pressure to distil away the remaining monomer (methyl acrylate) and the solvent (toluene). The resultant solid was dried for three hours in a vacuum dryer (80° C.), thereby obtaining 2.3 g of a random copolymer of methyl acrylate and ethylene. Results are shown in Table 4.

### Example 11

A 400 mL stainless-steel autoclave was dried sufficiently, and a gas in the autoclave was displaced with a nitrogen gas. There were put in the autoclave, at ordinary temperature and atmospheric pressure, using a syringe, 18 mL of methyl acrylate manufactured by Tokyo Chemical Industry Co., Ltd., 4 mL of a toluene solution of [octyl(tetramethyl)cyclopentadienyl]iron carbonyl dimer (transition metal compound) obtained in Reference Example 3 having a concentration of 0.05 mol/L, and 78 mL of purified toluene as a polymerization solvent. After heating the mixture up to 150° C., ethylene (olefin) was pressed into the autoclave up to its pressure of 4.0 MPa. Finally, 2.0 mL of a toluene solution of 2-iodobutane (manufactured by Tokyo Chemical Industry Co., Ltd.) having a concentration of 1.0 mol/L was put therein, thereby copolymerizing methyl acrylate and ethylene at 150° C. for 10 minutes. The copolymerization reaction mixture was subjected to distillation under reduced pressure to distil away the remaining monomer (methyl acrylate) and the solvent (toluene). The resultant solid was dried for three hours in a vacuum dryer (80° C.), thereby obtaining 18.5 g of a random copolymer of methyl acrylate and ethylene.

Said copolymer had a weight average molecular weight (Mw) of 43,000 and a number average molecular weight (Mn) of 21,000, in terms of a molecular weight of polystyrene. Its molecular weight distribution (Mw/Mn) of 2.0 was a single peak distribution. An amount of an ethylene unit contained in said copolymer was 4.6% by mol on the basis of a peak area of the base methyne carbon atom linked to the ester group (—COOCH₃) obtained by ¹³C NMR measurement. Results are shown in Table 5.

### Example 12

A 400 mL stainless-steel autoclave was dried sufficiently, and a gas in the autoclave was displaced with a nitrogen gas. There were put in the autoclave, at ordinary temperature and atmospheric pressure, using a syringe, 72 mL of methyl acrylate manufactured by Tokyo Chemical Industry Co., Ltd., 4 mL of a toluene solution of [octyl(tetramethyl)cyclopentadienyl]iron carbonyl dimer (transition metal compound) obtained in Reference Example 3 having a concentration of 0.05 mol/L, and 22 mL of purified toluene as a polymerization solvent. After heating the mixture up to 150° C., 2.0 mL of a toluene solution of 2-iodobutane (manufactured by Tokyo Chemical Industry Co., Ltd.) having a concentration of 1.0 mol/L was put therein, thereby polymerizing methyl acrylate at 150° C. for 10 minutes. The polymerization reaction mixture was subjected to distillation under reduced pressure to distil away the remaining monomer (methyl acrylate) and the solvent (toluene). The resultant solid was dried for three hours in a vacuum dryer (80° C.), thereby obtaining 18.5 g of a homopolymer of methyl acrylate.

Said homopolymer had a weight average molecular weight (Mw) of 45,000 and a number average molecular weight (Mn) of 23,000, in terms of a molecular weight of polystyrene. Its molecular weight distribution (Mw/Mn) of 2.0 was a single peak distribution. Results are shown in Table 5.

### Example 13

A 100 mL glass tube was dried sufficiently, and a gas in the tube was displaced with a nitrogen gas. There were put in the tube, at ordinary temperature and atmospheric pressure, using a syringe, 2.1 mL of methyl methacrylate manufactured by Kanto Chemical Co., Inc., 2.5 mL of 1-hexene manufactured by Tokyo Chemical Industry Co., Ltd., 4 mL of a toluene solution of [octyl(tetramethyl)cyclopentadienyl]iron carbonyl dimer (transition metal compound) obtained in Reference Example 3 having a concentration of 0.05 mol/L, and 1.2 mL of purified toluene as a polymerization solvent. Finally, 1.0 mL of a toluene solution of ethyl 2-iodoacetate (manufactured by Aldrich) having a concentration of 0.2 mol/L was put in the tube using a syringe, thereby copolymerizing methyl methacrylate and 1-hexene at 150° C. for 30 minutes. The copolymerization reaction mixture was subjected to distillation under reduced pressure to distil away the remaining monomers (methyl methacrylate and 1-hexene) and the solvent (toluene). The resultant solid was dried for three hours in a vacuum dryer (80° C.), thereby obtaining 1.4 g of a random copolymer of methyl methacrylate and 1-hexene.

Said copolymer had a weight average molecular weight (Mw) of 8,100 and a number average molecular weight (Mn) of 4,800, in terms of a molecular weight of polystyrene. Its molecular weight distribution (Mw/Mn) of 1.7 was a single peak distribution. Results are shown in Table 5.

### Example 14

A 100 mL glass tube was dried sufficiently, and a gas in the tube was displaced with a nitrogen gas. There were put in the tube, at ordinary temperature and atmospheric pressure, using a syringe, 2.1 mL of methyl methacrylate manufactured by Kanto Chemical Co., Inc., 4 mL of a toluene solution of [octyl(tetramethyl)cyclopentadienyl]iron carbonyl dimer (transition metal compound) obtained in Reference Example 3 having a concentration of 0.05 mol/L, and 1.2 mL of purified toluene as a polymerization solvent. Finally, 1.0 mL of a toluene solution of ethyl 2-iodoacetate (manufactured by Aldrich) having a concentration of 0.2 mol/L was put in the tube using a syringe, thereby homopolymerizing methyl methacrylate at 150° C. for 30 minutes. The polymerization reaction mixture was subjected to distillation under reduced pressure to distil away the remaining monomers (methyl methacrylate) and the solvent (toluene). The resultant solid was dried for three hours in a vacuum dryer (80° C.), thereby obtaining 1.0 g of a homopolymer of methyl methacrylate.

Said homopolymer had a weight average molecular weight (Mw) of 8,100 and a number average molecular weight (Mn) of 3,000, in terms of a molecular weight of polystyrene. Its molecular weight distribution (Mw/Mn) of 2.7 was a single peak distribution. Results are shown in Table 5.

### Example 15

A 100 mL glass tube was dried sufficiently, and a gas in the tube was displaced with a nitrogen gas. There were put in the tube, at ordinary temperature and atmospheric pressure, using a syringe, 6.9 mL of purified styrene, 4 mL of a toluene solution of [dodecyl(tetramethyl)cyclopentadienyl]iron carbonyl dimer (transition metal compound) obtained in Reference Example 2 having a concentration of 0.05 mol/L, and 7.1 mL of purified toluene as a polymerization solvent. Finally, 2.0 mL of a toluene solution of ethyl 2-iodoacetate (manufactured by Aldrich) having a concentration of 0.2 mol/L was put in the tube using a syringe, thereby homopolymerizing styrene at 60° C. for 30 minutes. The polymerization reaction mixture was subjected to distillation under reduced pressure to distil away the remaining monomers (styrene) and the solvent (toluene). The resultant solid was dried for three hours in a vacuum dryer (80° C.) thereby obtaining 4.6 g of a homopolymer of styrene.

Said homopolymer had a weight average molecular weight (Mw) of 21,000 and a number average molecular weight (Mn) of 12,000, in terms of a molecular weight of polystyrene. Its molecular weight distribution (Mw/Mn) of 1.7 was a single peak distribution. Results are shown in Table 5.

### Example 16

A 400 mL stainless-steel autoclave was dried sufficiently, and a gas in the autoclave was displaced with a nitrogen gas. There were put in the autoclave, at ordinary temperature and atmospheric pressure, using a syringe, 18 mL of methyl acrylate manufactured by Tokyo Chemical Industry Co., Ltd., 4 mL of a toluene solution of [dodecyl(tetramethyl)cyclopentadienyl]iron carbonyl dimer (transition metal compound) obtained in Reference Example 2 having a concentration of 0.05 mol/L, and 76 mL of purified toluene as a polymerization solvent. After adding ethylene (olefin) thereto, the mixture was heated up to 150° C., and ethylene (olefin) was pressed at 150° C. into the autoclave up to its pressure of 4.0 MPa, thereby stabilizing the system. Finally, 2.0 mL of a toluene solution of 2-iodobutane (manufactured by Tokyo Chemical Industry Co., Ltd.) having a concentration of 1.0 mol/L was put therein, thereby polymerizing methyl acrylate and ethylene at 150° C. for 10 minutes, this polymerization step being referred to as the first polymerization step.

The autoclave was cooled down to 20° C. or lower, and the inner pressure thereof was depressed till atmospheric pressure. There was added 50 mL of phenoxyethyl acrylate to the autoclave, and the mixture was heated again up to 150° C., thereby further polymerizing phenoxyethyl acrylate and the remaining methyl acrylate at 150° C. for 30 minutes, this polymerization step being referred to as the second polymerization step.

The polymerization reaction mixture was subjected to distillation under reduced pressure to distil away the remaining monomer (methyl acrylate and phenoxyethyl acrylate) and the solvent (toluene). The resultant solid was dried for three hours in a vacuum dryer (80° C.), thereby obtaining 21 g of a block copolymer consisting of (i) a random copolymer block of methyl acrylate with ethylene, and (ii) a random copolymer block of methyl acrylate with phenoxyethyl acrylate.

Said block copolymer had a weight average molecular weight (Mw) of 27,000 and a number average molecular weight (Mn) of 9,500, in terms of a molecular weight of polystyrene. Its molecular weight distribution (Mw/Mn) of 2.9 was a single peak distribution. Results are shown in Table 6.

It was confirmed on the basis of the following experimental facts that said block copolymer consisted of the above-mentioned random copolymer blocks (i) and (ii); namely, methyl acrylate and ethylene were random copolymerized in the first polymerization step, and then, methyl acrylate and phenoxyethyl acrylate were random copolymerized in the second polymerization step:

(1) a molecular weight of the polymer contained in the autoclave as of the close of the second polymerization step was higher than that of the polymer contained therein as of the close of the first polymerization step;

(2) the polymer contained in the autoclave as of the close of the second polymerization step had a strong absorbing property for an ultraviolet light based on a phenoxyethyl acrylate unit, whereas that contained therein as of the close of the first polymerization step had no absorbing property for an ultraviolet light; and

(3) data of the above-mentioned UV light-absorbing property of the polymer contained in the autoclave as of the close of the second polymerization step almost overlapped with data of its refractive index, which made an estimation that a phenoxyethyl acrylate unit existed uniformly in a random copolymer block of methyl acrylate with phenoxyethyl acrylate, namely, said unit was delocalized in said random copolymer block.

### Example 17

A 100 mL glass tube was dried sufficiently, and a gas in the tube was displaced with a nitrogen gas. There were put in the tube, at ordinary temperature and atmospheric pressure, using a syringe, 9.0 mL of methyl acrylate manufactured by Kanto Chemical Co., Inc., 10 mL of a toluene solution of [dodecyl(tetramethyl)cyclopentadienyl]iron carbonyl dimer (transition metal compound) obtained in Reference Example 2 having a concentration of 0.05 mol/L, and 30.0 mL of purified toluene as a polymerization solvent. Finally, 1.0 mL of a toluene solution of ethyl 2-iodoacetate (manufactured by Aldrich) having a concentration of 0.2 mol/L was put in the tube using a syringe, thereby homopolymerizing methyl acrylate at 60° C. for 30 minutes (first polymerization step). The polymerization reaction mixture was subjected to distillation to dryness under reduced pressure to distil away volatile matters such as the remaining monomers (methyl acrylate) and the solvent (toluene), and 22.9 mL of styrene and 27.1 mL of toluene were added to the remainder, thereby polymerizing styrene onto the above-produced poly(methyl acrylate) at 60° C. for 120 minutes (second polymerization step). The polymerization reaction mixture was subjected to distillation under reduced pressure to distil away the remaining monomers (styrene) and the solvent (toluene). The resultant solid was dried for three hours in a vacuum dryer (80° C.), thereby obtaining 1.2 g of a block copolymer of methyl acrylate and styrene.

Said block copolymer had a weight average molecular weight (Mw) of 47,000 and a number average molecular weight (Mn) of 26,000, in terms of a molecular weight of polystyrene. Its molecular weight distribution (Mw/Mn) of 1.8 was a single peak distribution. Results are shown in Table 6.

### Example 18

A 100 mL glass tube was dried sufficiently, and a gas in the tube was displaced with a nitrogen gas. There were put in the tube, at ordinary temperature and atmospheric pressure, using a syringe, 9.0 mL of methyl acrylate manufactured by Kanto Chemical Co., Inc., 5.6 mL of 1-hexene manufactured by Tokyo Chemical Industry Co., Ltd., 10 mL of a toluene solution of [dodecyl(tetramethyl)cyclopentadienyl]iron carbonyl dimer (transition metal compound) obtained in Reference Example 2 having a concentration of 0.05 mol/L, and 24.4 mL of purified toluene as a polymerization solvent. Finally, 1.0 mL of a toluene solution of ethyl 2-iodoacetate (manufactured by Aldrich) having a concentration of 0.2 mol/L was put in the tube using a syringe, thereby copolymerizing methyl acrylate with 1-hexene at 60° C. for 30 minutes (first polymerization step). The polymerization reaction mixture was subjected to distillation to dryness under reduced pressure to distil away volatile matters such as the remaining monomers (methyl acrylate and 1-hexene) and the solvent (toluene), and 22.9 mL of styrene and 27.1 mL of toluene were added to the remainder, thereby polymerizing styrene onto the above-produced copolymer of methyl acrylate with 1-hexene at 60° C. for 120 minutes (second polymerization step). The polymerization reaction mixture was subjected to distillation under reduced pressure to distil away the remaining monomers (styrene) and the solvent (toluene). The resultant solid was dried for three hours in a vacuum dryer (80° C.), thereby obtaining 1.3 g of a block copolymer consisting of (i) a random copolymer block of methyl acrylate with 1-hexene, and (ii) a homopolymer block of styrene.

Said block copolymer had a weight average molecular weight (Mw) of 24,000 and a number average molecular weight (Mn) of 12,000, in terms of a molecular weight of polystyrene. Its molecular weight distribution (Mw/Mn) of 2.0 was a single peak distribution. Results are shown in Table 6.

TABLE 1

| | | | Saturated solubility |
|---|---|---|---|
| | Transition metal compound | Solvent | (mmol at 23° C.)(Note-1) |
| Example 1 | [dodecyl(tetramethyl)cyclopentadienyl] | hexane | 131.4 |
| | iron carbonyl dimer | | |
| Example 2 | [dodecyl(tetramethyl)cyclopentadienyl] | toluene | 184.1 |
| | iron carbonyl dimer | | |
| Example 3 | [octyl(tetramethyl)cyclopentadienyl] | hexane | 96.8 |
| | iron carbonyl dimer | | |
| Example 4 | [octyl(tetramethyl)cyclopentadienyl] | toluene | 182.7 |
| | iron carbonyl dimer | | |
| Comparative Example 1 | (cyclopentadienyl)iron carbonyl dimer | hexane | 2.4 |
| Comparative Example 2 | (cyclopentadienyl)iron carbonyl dimer | toluene | 167.3 |
| Comparative Example 3 | [(pentamethyl)cyclopentadienyl]iron | hexane | 0.8 |
| | carbonyl dimer | | |
| Comparative Example 4 | [(pentamethyl)cyclopentadienyl]iron | toluene | 19.3 |
| | carbonyl dimer | | |

TABLE 2

| | | Comparative | | Comparative |
|---|---|---|---|---|
| | Example 5 | Example 5 | Example 6 | Example 6 |
| Reactor | 100 mL glass tube | | | |
| Transition metal compound | | | | |
| Kind (Note-2) | C₁₂Cp* | Cp* | C₁₂Cp* | Cp* |
| Amount (mmol/L) (Note-3) | 20 | 20 | 20 | 20 |
| Halogen-containing organic compound | | | | |
| Kind | ethyl 2-iodoacetate | | | |
| Amount (mmol/L) (Note-3) | 20 | | | |
| Monomer | | | | |
| Kind | butyl acrylate | butyl acrylate | butyl acrylate | butyl acrylate |
| Amount (mol/L) (Note-3) | 6 | 6 | 3 | 3 |
| Polymerization | | | | |
| Solvent | toluene | toluene | hexane | hexane |
| Temperature (° C.) | 20 | 20 | 40 | 40 |
| Time (hour) | 2 | 2 | 2 | 2 |
| Polymer | | | | |
| Yield (g) | 0.35 | 0.08 | 0.21 | 0.00 |
| Mw | 92,000 | — | 188,000 | — |
| Mn | 66,000 | — | 78,100 | — |
| Mw/Mn | 1.4 | — | 2.4 | — |

TABLE 3

| | | Comparative | Comparative | |
|---|---|---|---|---|
| | Example 7 | Example 7 | Example 8 | Example 8 |
| Reactor | 100 mL glass tube | | | |
| Transition metal compound | | | | |
| Kind (Note-2) | C₁₂Cp* | Cp* | C₁₂Cp* | Cp* |
| Amount (mmol/L) (Note-3) | 20 | 20 | 20 | 20 |
| Halogen-containing organic compound | | | | |
| Kind | ethyl 2-iodoacetate | | | |
| Amount (mmol/L) (Note-3) | 20 | | | |
| Monomer | | | | |
| Kind | butyl acrylate | | | |
| Amount (molIL) (Note-3) | 6 | | | |
| Polymerization | | | | |
| Solvent | toluene | toluene | toluene | toluene |
| Temperature (° C.) | 40 | 40 | 60 | 60 |
| Time (hour) | 2 | 2 | 2 | 2 |
| Polymer | | | | |
| Yield (g) | 4.0 | 1.6 | 6.0 | 1.8 |
| Mw | 704,000 | 646,000 | 611,000 | 818,000 |
| Mn | 97,800 | 107,000 | 192,000 | 209,000 |
| Mw/Mn | 7.2 | 6.1 | 3.2 | 3.9 |
| Polymer dipped in heptane | — | — | decolorized | non-decolorized |

TABLE 4

| | | Comparative | | Comparative |
|---|---|---|---|---|
| | Example 9 | Example 9 | Example 10 | Example 10 |
| Reactor | 400 mL stainless-steel autoclave | | | |
| Transition metal compound | | | | |
| Kind (Note-2) | C₁₂Cp* | Cp | C₁₂Cp* | Cp* |
| Amount (mmol/L) (Note-3) | 20 | 20 | 20 | 20 |
| Halogen-containing organic compound | | | | |
| Kind | 2-iodobutane | 2-chloropropionate | 2-iodobutane | 2-iodobutane |
| Amount (mmol/L) (Note-3) | 20 | 20 | 20 | 20 |
| Monomer (1) | | | | |
| Kind | methyl acrylate | | | |
| Amount (mol/L) (Note-3) | 2 | | | |
| Monomer (2) | | | | |
| Kind | ethylene | | | |
| Amount (MPa) | 4 | | | |
| uz,1/8 Polymerization | | | | |
| Solvent | toluene | toluene | toluene | toluene |
| Temperature (° C.) | 150 | 150 | 150 | 150 |
| Time (minute) | 10 | 30 | 10 | 30 |
| Color change of the reaction mixture | non-changed | changed | — | — |
| before and after polymerization | | | | |
| Polymer | | | | |
| Yield (g) | 8.7 | 0.5 | 2.6 | 2.3 |
| Mw | 6,300 | — | — | — |
| Mn | 4,500 | — | — | — |
| Mw/Mn | 1.4 | — | — | — |

TABLE 5

| | Example | | | | |
|---|---|---|---|---|---|
| | 11 | 12 | 13 | 14 | 15 |
| Reactor | 400 mL stainless-steel autoclave | | | | 100 mL glass tube |
| Transition metal compound | | | | | |
| Kind (Note-2) | C₈Cp* | | | | C₁₂Cp* |
| Amount (mmol/L) (Note-3) | 2 | | | | 10 |
| Halogen-containing organic compound | | | | | |
| Kind | 2-iodobutane | | ethyl 2-iodoacetate | | 2-iodobutane |
| Amount (mnol/L) (Note-3) | 20 | | 20 | | 20 |
| Monomer (1) | | | | | |
| Kind | methyl acrylate | methyl acrylate | methyl acrylate | methyl acrylate | styrene |
| Amount (mol/L) (Note-3) | 8 | 8 | 2 | 2 | 3 |
| Monomer (2) | | | | | |
| Kind | ethylene | — | 1-hexene | — | — |
| Amount | 4 MPa | — | 2 mol/L | — | — |
| Polymerization | | | | | |
| Solvent | toluene | toluene | toluene | toluene | toluene |
| Temperature (° C.) | 150 | 150 | 150 | 150 | 150 |
| Time (minute) | 10 | 10 | 10 | 10 | 30 |
| Polymer | | | | | |
| Yield (g) | 18.5 | 18.5 | 1.4 | 1.0 | 4.6 |
| Mw | 43,000 | 45,000 | 81,000 | 8,100 | 21,000 |
| Mn | 21,000 | 23,000 | 4,800 | 3,000 | 12,000 |
| Mw/Mn | 2.0 | 2.0 | 1.7 | 2.7 | 1.7 |

TABLE 6

| | Example | | |
|---|---|---|---|
| | 16 | 17 | 18 |
| Reactor | 400 mL autoclave | 100 mL glass tube | 100 mL glass tube |
| Halogen-containing organic compound | | | |
| Kind | 2-iodobutane | 2-iodobutane | 2-iodobutane |
| Amount (mmol/L) (Note-3) | 20 | 20 | 20 |
| 1st polymerization step | | | |
| Transition metal compound | | | |
| Kind (Note-2) | C₁₂Cp* | C₁₂Cp* | C₁₂Cp* |
| Amount (mmol/L) (Note-3) | 20 | 20 | 20 |
| Monomer (1) | | | |
| Kind | methyl acrylate | methyl acrylate | methyl acrylate |
| Amount (molIL) (Note-3) | 2 | 2 | 2 |
| Monomer (2) | | | |
| Kind | ethylene | — | 1-hexene |
| Amount | 4 MPa | — | 2 mol/L |
| Polymerization | | | |
| Solvent | toluene | toluene | toluene |
| Temperature (° C.) | 150 | 60 | 60 |
| Time (minute) | 10 | 30 | 30 |
| Distillation to dryness of the | no | yes | yes |
| polymerization reaction mixture | | | |
| 2nd polymerization step | | | |
| Monomer added | | | |
| Kind | phenoxyethyl acrylate | styrene | styrene |
| Amount (mol/L) (Note-3) | 2 | 4 | 4 |
| Polymerization | | | |
| Solvent added | — | toluene | toluene |
| Temperature (° C.) | 150 | 60 | 60 |
| Time (minute) | 30 | 120 | 120 |
| Polymer | | | |
| Yield (g) | 21 | 1.2 | 1.3 |
| Mw | 27,000 | 47,000 | 24,000 |
| Mn | 9,500 | 26,000 | 12,000 |
| Mw/Mn | 2.9 | 1.8 | 2.0 |

Note-1: The saturated solubility is an amount (mmol) of the transition metal compound dissolved in 10 mL of its saturated solution at 23° C.
Note-2: Cp is (cyclopentadienyl)iron carbonyl dimer; Cp* is [(pentamethyl)cyclopentadienyl]iron carbonyl dimer; C₈CP* is [octyl(tetramethyl)cyclopentadienyl]iron carbonyl dimer; and C₁₂CP* is [dodecyl(tetramethyl)cyclopentadienyl]iron carbonyl dimer.
Note-3: The amount represented by mmol/L or mol/L is a concentration of the compound or the monomer in the reaction system.

1. A transition metal compound represented by the following formula (1):
[(CpR¹ₘ)(CO)₂M¹][M²(CO)₂(CpR²ₙ)] (1)
wherein Cp is a cyclopentadienyl ring; R¹ and R² are independently of each other a hydrocarbyl group having 1 to 20 carbon atoms, and each of at least one R¹ and at least one R² is a hydrocarbyl group having 5 to 20 carbon atoms; m and n are independently of each other an integer of 1 to 5; and M¹ and M² are independently of each other a transition metal atom of the group 8 in the periodic table of elements.

2. The transition metal compound according to claim 1, wherein m is 5; n is 5; and one R¹ and one R² are independently of each other a hydrocarbyl group having 5 to 20 carbon atoms, and remaining four R¹s and four R^{2s} are a methyl group.

3. The transition metal compound according to claim 1, wherein M¹ and M² are an iron atom.

4. A polymerization-initiator system comprising the transition metal compound according to claim 1.

5. A polymerization-initiator system comprising the transition metal compound according to claim 1 and a halogen-containing organic compound.

6. A process for producing a polymer, which comprises the step of (i) polymerizing at least one kind of a polar monomer selected from the group consisting of an unsaturated carboxylic acid, an unsaturated carboxylic ester, an unsaturated carboxylic amide, a vinyl ether, a vinyl ester, an unsaturated nitrile, an unsaturated aldehyde and an unsaturated ketone, or (ii) polymerizing at least one kind of an olefin, or (iii) polymerizing the above-mentioned polar monomer and an olefin, in the presence of the polymerization-initiator system according to claim 4.

7. The process for producing a polymer according to claim 6, wherein the polar monomer is an acrylic ester or a methacrylic ester.

8. The process for producing a polymer according to claim 6, wherein the olefin is an α-olefin.

9. The process for producing a polymer according to claim 6, wherein the polymerizing step is a multiple-stage polymerizing step.

10. The process for producing a polymer wherein the polymerization-initiator system is that according to claim 5, and the polymerizing step is a multiple-stage polymerizing step.
